(19) United States
(12) Patent Application Publication
(10) Pub. No.: US 2026/0028705 A1
(43) Pub. Date: Jan. 29, 2026

(54) HOT-ROLLED HIGH-STRENGTH STEEL STRIP

(71) Applicant: TATA STEEL IJMUIDEN B.V., Velsen-Noord (NL)

(72) Inventors: Rolf Arjan RIJKENBERG, Santpoort-Noord (NL); Anton Romulus CHEZAN, Uitgeest (NL); Maxim Peter AARNTS, Castricum (NL); Paul Joseph BELLINA, Haarlem (NL); Sabri SENGO, Beverwijk (NL)

(21) Appl. No.: 19/099,800

(22) PCT Filed: Jun. 12, 2023
(86) PCT No.: PCT/EP2023/065663

§ 371 Date: Jan. 30, 2025

(30) Foreign Application Priority Data
Aug. 9, 2022 (EP) 22189383.7

(51) Int. Cl. C22C 38/14; B32B 15/01; C21D 1/18; C21D 6/00; C21D 8/02; C21D 9/52; C22C 38/00; C22C 38/02; C22C 38/04; C22C 38/06

(52) U.S. Cl. CPC C22C 38/14; B32B 15/012; B32B 15/013; C21D 1/18; C21D 6/005; C21D 6/008; C21D 8/0205; C21D 8/0226; C21D 8/0263; C21D 8/0278; C21D 9/52; C22C 38/001; C22C 38/002; C22C 38/02; C22C 38/04; C22C 38/06; C21D 2211/002; C21D 2211/003; C21D 2211/005; C21D 2211/008

(57) ABSTRACT

Hot-rolled high-strength steel strip having, in wt. %, C: 0.06-0.12, Mn: 1.20-2.20, Ti: 0.07-0.15, Si: up to 0.65, Al: up to 0.10, P: up to 0.02, S: up to 0.01, Nb: up to 0.03, N: up to 0.01; microstructure of: precipitation-strengthened acicular/bainitic ferrite and/or bainite with MOD index of at least 0.85 at ¼-thickness, at most 5 vol. % second-phase constituents, average grain size by number at ¼-thickness in rolling direction based on grain tolerance angle of 15° (GSN15) at most 2.0 μm, total high-angle grain boundary length (ΣGBL15-65) at ¼-thickness at least 1060 mm−1, and γ-fibre X-ray random intensity ratio at least 27 as measured with XRD at ½-thickness; and yield strength 600-820 MPa, ultimate tensile strength 730-950 MPa, tensile elongation at least 11%, a hole-expansion capacity at least 45%, and work of fracture at least 100 J. A method of manufacturing such strip.

### FIELD OF THE INVENTION

The invention relates to a hot-rolled high-strength steel strip, and which is in particular suitable for, but not limited to, use in automotive components. The invention also relates to a method of manufacturing such a hot-rolled high-strength steel strip. Furthermore, the invention relates to an automotive part incorporating the hot-rolled high-strength steel strip.

### BACKGROUND TO THE INVENTION

It is well-known that as the strength of hot-rolled (HR) steel strip increases, the formability decreases as well as the fracture toughness in terms of crack susceptibility and the susceptibility to unstable brittle fracture may be compromised. A major area of application for HR steels in transport and automotive applications is the chassis and suspension (C&S). Other areas include frame rails of trucks, bumper beams or battery boxes for electrical vehicles. The typical thickness of hot-rolled steels used for these applications is less than 8 mm, and is commonly less than 6 mm or less than 4.5 mm. Thicker gauge HR steel strip such as up to 12 mm can be used in engineering applications such as crane booms or in transport applications for frames of heavy trucks. From the weight reduction perspective it is imperative that higher strength steels should be employed for the above applications in order to be able to reduce the gauge of the steel strip. These applications of the hot-rolled steels demand mechanical properties that are difficult to reconcile. Beside a high strength the steel strip should also have good formability for making the component via e.g. cold-forming because this is an energy efficient manufacturing route in comparison with hot-forming. Furthermore, good impact and fracture toughness or energy absorption capacity is also required for applications like bumper beams, battery housings, crane booms or frame rails. For assembling the components, also a good weldability is required. However, as the tensile strength of the steels increases the formability parameters decrease. Formability is a generic term for steel sheets which is viewed as a combination of material behaviour during several mechanical operations such as stretching, bending, drawing and flanging. Depending on the component geometry any or a combination of two or more attributes of the material is of importance during sheet metal forming. Next to formability, also the fracture toughness may be compromised with an increase of the strength. This can lead to increased crack susceptibility and increased susceptibility to unstable brittle crack propagation under specific mechanical loading conditions, such as local compression in deep-drawing operations.

Another important characteristic for steels used for structural components in transport and automotive applications is their response to shearing in terms of splitting or delamination. Some steels may be prone to delamination upon shearing, i.e., mechanical cutting or punching, with typical industrially relevant clearances, i.e., typically ranging from about 10% to 18% with a typical average value around 12%. This delamination is visible as cracks or splits in the fractured zone of the sheared edge running perpendicular to the movement of the shearing device during shearing. These splits in the fractured zone of the sheared edge can act as notches and consequently lead to a deterioration of the sheared-edge fatigue and hence compromise the in-service performance of structural components in transport of automotive applications subjected to cyclic loading.

To spare component weight, the common approach is to apply high-strength steel and to reduce the thickness of the steel strip used to save weight. However, this may lead to a loss in stiffness, which for some applications in automotive parts is undesirable. The intrinsic loss in stiffness by reducing the thickness of the steel strip used to manufacture automotive components, can be regained by optimisation of the component geometry, e.g. creating deeper flanges or flanges with an increased degree of stretching or bending. To allow for increased component stiffness via geometry optimisation, the high-strength steel strip requires an excellent formability in terms of tensile elongation and hole expansion capacity.

Single-phase precipitation-strengthened ferritic high-strength steels that break free from the conventional constraints between global formability (e.g. tensile elongation) and local formability (e.g., hole-expansion capacity or HEC) with both formability modes at a high level, may have low fracture toughness values and increased edge crack sensitivity in certain conditions, e.g., under compression, and are prone to have increased susceptibility to unstable brittle fracture behaviour as well as delamination during shearing, which impairs sheared-edge fatigue.

Patent document EP1616970-A1 discloses a method for manufacturing a high-strength hot-rolled steel sheet comprising the steps of: reheating a steel slab consisting of, in wt. %, 0.04-0.15% C, 1.5% or less Si, 0.5-1.6% Mn, 0.04% or less P, 0.005% or less S, 0.04% or less Al, 0.03-0.15% Ti, 0.03-0.5% Mo, by mass, and balance of Fe and inevitable impurities, in a temperature range from 1150-1300° C.; hot rolling the reheated steel slab at a finishing temperature of the Ar₃ transformation temperature or above into a hot rolled steel sheet; primarily cooling the hot rolled steel sheet in a temperature range from 700-850° C. at an average cooling rate of 20° C./s or more; holding the primarily cooled steel sheet at a temperature of 680° C. or above for more than 1 sec; and secondarily cooling the steel sheet at a temperature of 550° C. or below at an average cooling rate of 30° C./s or more, followed by coiling the steel sheet. Preferably, the hot-rolled steel sheet is primarily cooled to a temperature range not only from 700-850° C. but also from (SRT/3+300) to (SRT/8+700)° C., where the SRT designates the reheating temperature of the steel slab. In the examples of EP1616970-A1 this leads in practice to primary holding temperatures ranging from 667-860° C. The processing conditions are such that a microstructure is obtained which consists of ferrite containing precipitates, second phase of bainite and/or martensite, and other phase, wherein the percentage of the ferrite containing precipitates is 40-95%, and the percentage of the other phase being 5% or less.

Patent document EP1338665-A1 discloses a method for manufacturing a high-strength hot-rolled single-phase ferritic steel with nano-precipitates steel sheet, comprising the steps of: producing a steel slab which consists essentially of, in wt. %, 0.06% or less C, 0.5% or less Si, 0.5-2.0% Mn, 0.06% or less P, 0.005% or less S, 0.1% or less Al, 0.006% or less N, 0.05-0.6% Mo, 0.02-0.10% Ti, and the balance being Fe, and satisfies the equation of 0.8≤ (C/12)/[(Ti/48)+(Mo/96)]≤1.3; producing a hot rolled steel sheet by hot rolling said steel slab at a temperature of Ar₃ transformation point or higher; and coiling said hot rolled steel sheet at a temperature of 550-700° C. The processing conditions are such that a microstructure is obtained that consists essentially of a matrix of ferrite structure single phase and fine precipitates which are composite carbides containing Ti and Mo, with a grain size of smaller than 10 nm dispersed in said matrix wherein said fine precipitates are dispersed at a number per unit volume of 5×10⁴/mm³ or higher.

Patent document WO2013/167572-A1 discloses a high-strength hot-rolled single-phase ferritic steel with nano-precipitates steel sheet with an excellent combination of tensile strength of at least 550 MPa and formability, comprising in wt. %, at most 0.15% of C, at most 0.5% of Si, 0.5-2.0% of Mn, at most 0.06% of P, at most 0.008% of S, at most 0.1% of Al_sol, at most 0.02% of N, 0.02-0.45% of V, 0.05-0.7% of Mo, optionally between 0.01-0.1% of Nb, balance of Fe and inevitable impurities, wherein the steel sheet has a precipitation strengthened and substantially single-phase ferritic microstructure, wherein the volume fraction of the ferrite phase in said microstructure is not lower than 97%, and wherein the precipitates in said microstructure comprise fine precipitates of composite carbides containing Mo and V and optionally Nb. The hot-rolled steel strip has been manufactured by means of hot rolling at a finish hot rolling temperature of Ar₃ transformation point or higher, and coiling the hot-rolled sheet in the temperature range of between 700° C. and 585° C.

Patent document WO2018/193032-A1 discloses a high-strength steel strip having a cementite-free microstructure comprising: 0.005-0.08 wt. % C; 1.30-2.30 wt. % Mn; 2-35 ppm B; 5-65 ppm N; 0.005-0.1 wt. % Al_tot; 0.03-0.20 wt. % Ti; 0-1.5 wt. % Cu; 0-0.75 wt. % Cr; 0-0.05 wt. % Mo; 0-0.50 wt. % Ni; 0-0.30 wt. % V; 0-0.6 wt. % Si; 0-0.01 wt. % P; 0-0.01 wt. % S; C/(Ti_sol+V)≤0.25 with Ti_sol=Ti−((48/14)−N), remainder iron and inevitable impurities, the steel strip having a yield strength of at least 570 MPa, a tensile strength of at least 760 MPa, a total elongation (A50) of at least 10.3% and a hole expansion ratio (λ) value of at least 70%. The steel strip has been manufactured by hot rolling, cooling the hot-rolled strip with an average cooling rate of 15-100° C./s on the run-out table within a time period of 2 seconds between the finish rolling and start of cooling to a coiling temperature below 500° C., and then coil cooling by natural cooling to ambient temperature, cold rolling with a reduction between 50-90%, and preferably followed by a solution heat-treatment to allow the bainitic transformation.

There is a demand for hot-rolled high-strength well-drawable steels that, next to sufficient strength for down gauging and weight saving, offer a suitable combination of global (tensile elongation) and local (hole-expansion capacity) formability for component geometry optimisation and adequate stiffness while also providing an adequate level of fracture toughness to minimise brittle fracture behaviour and sheared-edge quality without splitting or delamination with industrially relevant shearing clearances for optimum sheared-edge fatigue, and thereby realising an optimum balance for all these material characteristics, i.e., formability in terms of tensile elongation and hole-expansion capacity, fracture toughness in terms of crack susceptibility and work of fracture, and susceptibility to splitting upon shearing.

### DESCRIPTION OF THE INVENTION

As will be appreciated herein, for any description of alloy compositions or preferred alloy compositions, all references to percentages are by weight percent unless otherwise indicated.

As used herein, the term “about” when used to describe a compositional range or amount of an alloying addition means that the actual amount of the alloying addition may vary from the nominal intended amount due to factors such as standard processing variations as understood by those skilled in the art.

The term “up to” and “up to about”, as employed herein, explicitly includes, but is not limited to, the possibility of zero weight-percent of the particular alloying component to which it refers. For example, up to 0.20% Cu may include a steel having no Cu.

As used herein, the term “at ¼ thickness” when used to describe microstructural features as determined by microscopy techniques, and in particular by Electron BackScatter Diffraction (EBSD), refers to an area between ⅛ and ⅜ of the steel strip thickness below the surface of the steel strip, and preferably between 3/16 and 5/16 of the steel strip thickness below the surface of the steel strip.

As used herein, the term “at ½ thickness” when used to describe textural features as determined by X-Ray Diffraction (XRD) refers to an area between ⅜ and ⅝ of the steel strip thickness below the surface of the steel strip, and preferably between 7/16 and 9/16 of the steel strip thickness below the surface of the steel strip.

It is an object of the invention to provide a hot-rolled high-strength deep-drawable steel strip with high edge ductility in terms of hole-expansion capacity, adequate fracture toughness and good shearing performance substantially free of splitting or delamination, that is in particular suitable for complex components for automotive applications.

It is an object of the invention provide a hot-rolled high-strength deep-drawable steel strip having a yield strength ranging between 600 MPa to 820 MPa, an ultimate tensile strength ranging between 730 and 950 MPa, and with a high edge ductility in terms of hole-expansion capacity, adequate fracture toughness and good shearing performance that is in particular suitable for complex components for automotive applications.

It is another object of the invention to provide a method of manufacturing such a hot-rolled high-strength deep-drawable steel strip having an improved balance of having a yield strength ranging between 600 MPa to 820 MPa, an ultimate tensile strength ranging between 730 and 950 MPa, and with high edge ductility in terms of hole-expansion capacity, adequate fracture toughness and good shearing performance substantially free of splitting or delamination.

These and other objects and further advantages are met or exceeded by the present invention providing a hot-rolled high-strength steel strip having a composition, in wt. %,

C: 0.06-0.12 wt. %, Mn: 1.20-2.20 wt. %, Ti: 0.07-0.15 wt. %, Si: up to 0.65 wt. %, Al: up to 0.10 wt. %, P: up to 0.02 wt. %, S: up to 0.01 wt. %, Nb: up to 0.03 wt. %, N: up to 0.01 wt. %, optionally one or more elements selected from the group consisting of: (Cr: up to 0.25 wt. %, Mo: up to 0.10 wt. %, V: up to 0.30 wt. %, Cu: up to 0.20 wt. %, Ni: up to 0.50 wt. %, B: up to 0.005 wt. %), and balance Fe and inevitable impurities resulting from the ironmaking and steelmaking process;

and wherein the steel strip has a microstructure of:
precipitation-strengthened acicular/bainitic ferrite and/or bainite,
a MisOrientation Distribution (MOD) index of at least 0.85 at ¼-thickness,
at most 5 vol. % of second-phase constituents, including cementite, pearlite, martensite, and/or retained-austenite,
an average grain size by number at ¼-thickness in the rolling direction and based on a grain tolerance angle of 15° (GS_{N15}) of at most 2.0 μm,
a total high-angle grain boundary length (ΣGBL₁₅₋₆₅) at ¼-thickness of at least 1060 mm⁻¹, and
a γ-fibre X-ray random intensity ratio of at least 27 as measured with XRD at ½-thickness;

and wherein the steel strip has at least the following mechanical properties: a yield strength (Rp0.2) ranging from 600 to 820 MPa, an ultimate tensile strength (Rm) ranging between 730 and 950 MPa, a tensile elongation (A50) of at least 11%, a hole-expansion capacity (HEC) of at least 45%, and a work of fracture (WOF) of at least 100 J.

In accordance with the invention it has been found that the hot-rolled steel strip having these narrow alloy compositional ranges in combination with the microstructure provides for an improved balance of a combined high edge ductility as expressed by hole-expansion capacity (viz., HEC≥45%) with adequate fracture toughness (e.g., ATCL≤20 mm), and work of fracture (WOF)≥100 J, and good shearing performance with substantially no splitting/delamination for a hot-rolled deep-drawable steel strip, the hot-rolled steel strip having a yield strength (Rp0.2) ranging between 600-820 MPa, a tensile strength (Rm) ranging between 730-950 MPa, and a tensile elongation A50 of 11% or higher, and preferably tensile elongation A50 of 14% or higher.

A reduced crack sensitivity, in particular a reduced edge-crack sensitivity, can be objectively expressed in an average total crack length (ATCL) following the measuring method as herein described. The steel strip according to this invention has an ATCL of less than 20 mm, preferably of less than 10 mm, more preferably of less than 8 mm, and most preferably of less than 5 mm.

The work of fracture (WOF) is considered as a measure for the fracture toughness of the steel sheet and is ≥100 J. In an embodiment the WOF≥125 J, and preferably WOF≥140 J. In an embodiment the WOF is at least 180 J, and preferably at least 200 J.

The required microstructure for this hot-rolled high-strength steel strip is achieved by the narrow compositional ranges and by careful control of the manufacturing process, e.g., the finish rolling temperature (FRT), the controlled cooling of the hot-rolled steel strip on the run-out table (ROT) and the narrow operating window for the coiling temperature (CT) in particular.

Based on extensive research, the inventors have found an empirical relationship (with R² of circa 0.86) for the hole-expansion capacity (λ) and a factor, called T factor, which is defined as the MOD index to the power 1.2 times the ratio of the sum of the X-ray random intensity ratios of the γ-fibre, θ-fibre, and {110}<001> Goss texture component divided by the sum of the X-ray random intensity ratios of the α*-segment, {112}<131>, {332}<113>, and {554}<225> texture components according to:

$$T = \frac{[ ( γ - fibre + ( θ - fibre ) + \{ 110 \} 〈 001 〉 ]}{[ ( {α}^{*} - segment ) + \{ 1 \; 12 \} 〈 131 〉 + \{ 3 \; 32 \} 〈 113 〉 + \{ 5 \; 54 \} 〈 225 〉 ]} \times {MOD}^{1 , 2}$$

The α*-segment is here defined as the segment of the α-fibre in the φ2=45° section of Euler space or Orientation Distribution Function (ODF) running from the {115}<110> to the {223}<110> (and including the X-ray random intensity ratios of these outer two texture components), which covers the 15° to 45° range on the α-fibre.

The defined T factor should be at least 1.1. In an embodiment the T factor is at least 1.15, and more preferably at least 1.4. An increased T factor provides an increased HEC. When GS_{N15} is too high (e.g., >2.0 μm at ¼-thickness) and/or ΣGBL₁₅₋₆₅ too low (<1060 mm⁻¹ at ¼-thickness), the work of fracture is too low and some splitting at shearing may still occur, and therefore it is preferred that the T factor is at most 1.8.

To achieve a hole-expansion capacity (HEC) of λ≥45%, preferably of λ≥50%, and more preferably of λ≥60%, the microstructure requires an essentially acicular/bainitic ferrite and/or bainite fine-grained microstructure. The amount of second-phase constituents, including cementite, pearlite, martensite, and/or retained-austenite should in total not exceed 5 vol. %, and preferably does not exceed 3 vol. %, as too high a fraction of hard carbon-rich second-phase constituents will lead to too much damage upon shearing, which is at the expense of the hole-expansion capacity.

In addition, a MisOrientation Distribution (MOD) index of at least 0.85 at ¼-thickness is required, preferably of at least 0.90, more preferably of at least 0.95, and most preferably of at least 1.0. In general, an increase of the MOD index is associated with an increase of the hole-expansion capacity. The MOD index is a measure for the character of the microstructure, which is dominated by the phase constituents making up the matrix. High-temperature phase constituents, for instance polygonal ferrite will typically have a low MOD index. As the transformation temperature drops down, the ferrite morphology will shift to quasi-polygonal or irregular-shaped ferrite, through acicular and/or bainitic (feathered) ferrite towards upper bainite and eventually lower bainite, before reaching martensite. With this change in matrix morphology, which is largely related to the ROT cooling trajectory and foremost to the coiling temperature, the MOD index will increase. In general, a decrease of the coiling temperature will lead to an increase of the MOD index. It is believed that an increased MOD index leads to a more intricate crystallographic arrangement that is beneficial for improved hole-expansion capacity and that the increased MOD index from a reduced coiling temperature comes with refined cementite particles due to reduced diffusivity, which is beneficial to suppress damage and void formation upon shearing and to suppress void coalescence and crack formation upon stretch-flanging sheared edges.

It is an important feature of the invention that the microstructure has to be sufficiently grain-refined and is being characterized by an average grain size by number at ¼-thickness in the rolling direction and based on a grain tolerance angle of 15° (GS_{N15}) of at most 2.0 μm, preferably of at most 1.9 μm, more preferably of at most 1.8 μm, and most preferably of at most 1.7 μm, and a total grain boundary length at ¼-strip thickness in the rolling direction and based on neighbouring grain misorientation of 15° to 65° (ΣGBL₁₅₋₆₅) of at least 1060 mm per mm² (mm⁻¹) as measured by EBSD, preferably of at least 1100 mm⁻¹, more preferably of at least 1200 mm⁻¹, and most preferably of at least 1300 mm⁻¹. High-angle grain boundaries are effective to suppress or arrest crack propagation. Hence, grain refinement and an increased density of high-angle grain boundaries are beneficial for increased fracture toughness as well as for shearing performance, leaving behind a more smooth fracture zone after shearing, which in turn is beneficial for sheared-edge fatigue. This grain refinement has been realised by controlling an adequate interplay between alloy composition and hot-rolling processing parameters. In relation to the hot-rolling process, a lower finish rolling temperature, leading to increased rolling below the non-recrystallisation temperature Tₙᵣ will be beneficial to promote grain refinement of the final microstructure. However, also specific alloying elements in the steel composition will play a role as they have an influence on the Tₙᵣ. Apart from micro-alloying elements niobium, if present, and titanium to increase the Tₙᵣ to increase the fraction non-recrystallised austenite at the end of hot-rolling and prior to phase transformation, also carbon has a beneficial influence to increase Tₙᵣ. An increase of the carbon content leads to an increase of Tₙᵣ, which is beneficial to increase the fraction unrecrystallised austenite at the end of the hot-rolling process prior to austenite-to-ferrite phase transformation, which in turn will promote grain refinement of the final microstructure. Next to the effect of hot rolling and Tₙᵣ, also the Ar₃ phase transformation temperature plays a role to determine the average grain size of the final microstructure. Carbon suppresses the Ar₃ austenite-to-ferrite phase transformation, which will promote grain refinement. Thus carbon is beneficial to promote grain refinement of the final microstructure through its effect on non-recrystallisation temperature Tₙᵣ and the austenite-to-ferrite phase transformation temperature Ar₃, which in turn is beneficial for improved fracture toughness and shearing performance.

In addition, an increased fraction non-recrystallised austenite at the end of hot-rolling and prior to phase transformation increases the X-ray random intensity ratios of the {554}<225> and—in particular—{332}<113> texture components, which are associated with increased fracture toughness and beneficial to reduce the average total crack length (ATCL) and to increase the work of fracture (WOF). Also, an increased fraction non-recrystallised austenite at the end of hot-rolling and prior to phase transformation decreases the X-ray random intensity ratios of the {001}<110> rotated Cube and {110}<001> Goss, which are associated with embrittlement, delamination behaviour of steels upon fracture, and splitting upon shearing.

At the same time, a too high fraction non-recrystallised austenite at the end of hot-rolling and prior to phase transformation has to be avoided as this increases the X-ray random intensity ratios of the {112}<110> and—in particular—{113}<110> and {112}<131> texture components, which are associated with increased (planar) anisotropy, leading potentially to reduced drawability and also hole-expansion capacity.

On the other hand, a too low fraction non-recrystallised austenite at the end of hot-rolling and prior to phase transformation can lead to too high X-ray random intensity ratios of the {001}<110> rotated Cube and {110}<001> Goss texture components, which are associated with reduced drawability, embrittlement of the steel, and delamination behaviour upon fracture or shearing.

The hot-rolled steels of this invention have a microstructure being precipitation-strengthened acicular/bainitic ferrite and/or bainite. This means that at least 95 vol. % (volume fraction) of the microstructure is formed by the precipitation-strengthened acicular/bainitic ferrite and/or bainite, and more preferably by at least 97 vol. %, and most preferably by at least 98 vol. %.

The steels have at most 5 vol. % second-phase constituents, including any cementite, pearlite, martensite, and/or retained-austenite, and preferably at most 3 vol. % second-phase constituents, and hence limited internal microstructural damage upon shearing; the hole-expansion capacity is largely plasticity driven and less damage controlled and subsequently linked to the r-value and hence to the drawability of the steel. In other words, the hole-expansion capacity is largely dictated by the amount of in-plane plastic strain transverse to the loading direction over the amount of plastic strain through-the-thickness. Hence, for these steels, i.e., high-strength steels is at most 5 vol. % second-phase constituents, and preferably at most 3 vol. % second-phase constituents, and more preferably at most 2 vol. %, an improvement of the drawability of the steel can be found and hence increasing the mean or normal r-value (rₘ):

$${r}_{m} = \frac{1}{4} ( {r}_{0} + 2 {r}_{45} + {r}_{90} )$$

and decreasing the planar anisotropy coefficient (rₚ):

$${r}_{p} = \frac{1}{2} ( {r}_{0} - 2 {r}_{45} + {r}_{90} )$$

or increasing the minimum r-value (rₘᵢₙ) in a particular direction. The drawability and r-value increase with an increase of the intensity of the γ-fibre which is associated with grains having {111} planes parallel to the sheet surface at the expense of the intensity of texture components on the α-fibre, which are associated with grains having {100} planes parallel to the sheet surface. Hence, for the present invention relating to a hot-rolled high-strength steel strip with a hole-expansion capacity of at least 45%, preferably at least 50%, and most preferably at least 60%, a hot-rolled texture is required at ½ strip thickness with a γ-fibre in the ϕ2=45° orientation distribution function (ODF) with a X-ray random intensity ratio of at least 27. In a preferred embodiment the X-ray random intensity ratio of the γ-fibre is at least 30, and more preferably at least 35.

The hole-expansion capacity can also be (further) increased at the expense of fracture toughness by increasing the intensity of the {001}<110> rotated Cube on the θ-fibre in the ϕ2=45° orientation distribution function (ODF) and {110}<001> Goss. These are texture components that are associated with embrittlement and delamination. Though this is detrimental for fracture toughness and sheared-edge quality in terms of splitting upon shearing, the increased susceptibility to delamination promotes crack propagation in RD-TD planes (RD=rolling direction; TD=transverse direction) parallel to the steel strip surface. These preferential crack paths in RD-TD planes can be beneficial to deflect crack propagation, e.g., in a hole-expansion capacity test, and in this way retard or arrest fracture propagation through the thickness, i.e., the ND direction (ND=normal direction). Since a fracture through the complete thickness of the steel strip is the criterium for the determination of the edge ductility by means of the hole-expansion capacity test, any deflection of the main crack travelling through the thickness can delay the development of a full-develop through-the-thickness fracture. This leads to increased hole-expansion capacity though simultaneously may be associated with reduced fracture toughness and increased susceptibility to splitting upon shearing.

Carbon is present in an amount between 0.06 and 0.12 wt. %. To achieve sufficient strength, a suitable minimum C content is 0.060 wt. %. In a preferred embodiment at least 0.07 wt. %, and more preferably the C content is at least 0.075 wt. %. Carbon is beneficial to promote grain refinement of the final microstructure through its effect on the non-recrystallisation temperature Tₙᵣ and the austenite-to-ferrite phase transformation temperature Ar₃, which in turn is beneficial for improved fracture toughness and shearing performance. In addition, C is an essential element to achieve precipitation strengthening in combination with carbide-forming micro-alloying elements like titanium, niobium (if added) and/or vanadium (if added), and to scavenge C to suppress a too high fraction of cementite or other carbon-rich secondary phase constituents in the final microstructure. By optimizing other alloying elements, including Ti, Nb, and/or V, it is possible to obtain an almost uniform precipitation-strengthened acicular/bainitic ferrite and/or bainite microstructure with substantially no or very little cementite. In a preferred embodiment the C content is at most 0.10 wt. % to prevent too much second-phase constituents in the final microstructure, which may deteriorate hole-expansion capacity.

The steel strip has Mn in a range of about 1.20 wt. % to 2.20 wt. % to achieve sufficient hardenability and grain refinement. Next to carbon also manganese suppresses the Ar₃ transformation temperature and is thus beneficial to promote grain refinement of the final microstructure. In an embodiment the Mn content is in a range of about 1.40 wt. % to 2.20 wt. % for an improved balance in strength, corrosion resistance, fracture toughness and edge crack sensitivity. Preferably the Mn content is at least about 1.50 wt. %, more preferably at least about 1.60 wt. %, and most preferably at least 1.70 wt. %, to obtain sufficient grain refinement improving the fracture toughness and reducing the crack susceptibility. In an embodiment the Mn content is maximum about 2.10 wt. %, and more preferably maximum about 2.0 wt. %. A too high Mn content may lead to segregation during casting which adversely affects the required balance in properties.

Titanium is another essential alloying element and is present in an amount between about 0.07 wt. % and 0.15 wt. % as it provides hardenability and acts as a carbide forming element suppressing the formation of cementite while providing precipitation strengthening via the formation of small Ti-based carbides. However, Ti also combines with N, S and C to form nitrides, and carbo-sulphides, depending on the specific chemical composition of the steel. Therefore, preferably at least about 0.08 wt. % Ti is present to bind substantially all the N and S in the steel and to have sufficient excess Ti to combine with C in the steel. In a preferred embodiment at least about 0.09 wt. % Ti is present. When more than about 0.15 wt. % Ti is present, coarse Ti nitrides, carbo-nitrides, and carbides may form which are difficult to dissolve during reheating of the slab prior to hot rolling. Furthermore, these coarse Ti nitrides, carbo-nitrides, and carbides lead to a deterioration of the hole expansion capacity of the steel. In an embodiment the Ti content does not exceed 0.13 wt. %, and preferably does not exceed 0.12 wt. %.

The composition of the steel according to this invention has C/(Ti_sol+V)>0.25 preferably >0.30, and more preferably >0.40, and where Ti_sol represents the amount of Ti that can form carbides and is calculated using

$${Ti}_{sol} = Ti - ( \frac{48}{14} ) \cdot N ,$$

and emphasises the role of carbon to promote grain refinement.

Silicon may be present up to about 0.65 wt. %, and is preferably present in an amount of about 0.10 to 0.65 wt. % to improve the strength of the steel by substitutional solid solution strengthening of the iron lattice. Furthermore, Si is beneficial to suppress cementite formation. However, when using higher amounts of Si the weldability and coatability of the steel deteriorates, hence the amount of Si is preferably at most about 0.55 wt. %, and in a preferred embodiment at most about 0.50 wt. %. In an embodiment the amount of Si is at least about 0.20 wt. %, and more preferably at least about 0.25 wt. %.

Aluminium behaves comparable to Si in the steel according to the invention. It slows down the carbide precipitation kinetics and suppresses the formation of cementite. When Al is less than about 0.01 wt. %, the effects of suppression of carbide formation are negligible. Values of aluminium lower than 0.01 wt. % are deemed to be residuals from the deoxidation step during steelmaking, and therefore a minimum value of about 0.01 wt. % is preferred. On the other hand, when Al is above about 0.10 wt. % there can be excessive oxide formation during thermo-mechanical processing (slab reheating, hot rolling, coiling etc.) of the steel, which can deteriorate formability and toughness. Also, with increasing Al higher amounts of surface oxidation can occur at higher temperatures. These oxide scales are detrimental for hot rolling, pickling, coating and overall surface appearance. Also, the rolling forces during hot rolling increase when the Al increases in combination with the presence of Si to such a level making the steel very brittle and more difficult to hot-roll. Therefore, Al in the present invention is present in an amount of up to about 0.10 wt. %, preferably in a range of about 0.01-0.10 wt. %, and more preferably in the range of about 0.03-0.08 wt. %.

Nitrogen, sulphur and phosphorus are residual elements present in the steel as a result of steel making and refining process. Their amounts are limited to up to about 0.01 wt. % S, up to about 0.02 wt. % P, and up to about 0.01 wt. % N. Amounts higher than these are detrimental for mechanical properties, formability, toughness, sheared-edge quality, fatigue, and weldability. In an embodiment P is present only up to 0.015 wt. %. In an embodiment S is present only up to 0.005 wt. % (50 ppm) and more preferably only up to 0.0025 wt. % (25 ppm), and most preferably up to 0.0012 wt. % (12 ppm). N forms titanium nitrides with Ti which act as dispersoids for austenite grain size control during reheating. However, too high N can lead to too much coarse TiN particles that can impair hole expansion capacity. Preferably the N content is up to 0.0075 wt. % (75 ppm), and more preferably up to 0.0065 wt. % (65 ppm). A suitable minimum N content is about 0.0010 wt. % (10 ppm).

Niobium can be present in the steel up to 0.03 wt. %. Nb improves the strength of the steel partly by precipitation hardening but foremost by grain refinement. This grain refinement is also beneficial for increased fracture toughness. However, as Nb is a rather expensive alloying element and can promote anisotropy, the Nb content preferably does not exceed 0.025 wt. %, more preferably it does not exceed 0.02 wt. %, even more preferably it does not exceed 0.018 wt. %. In an embodiment the Nb content is at least 0.005 wt. %, and more preferably at least 0.010 wt. %. It has been found that by keeping the Ti at a sufficient high level, the use of Nb can be overcome while still arriving at the aimed balance of formability, mechanical properties and improved fracture or edge-cracking characteristics. Also, Nb can promote increased anisotropy and additionally has a high tendency to segregate and to form coarse NbC particles due to centre-line segregation, thus the avoidance of the use of Nb results in an improved hole-expansion capacity and increased sheared-edge quality.

In another embodiment Nb is not purposively added and only present as an inevitable impurity resulting from the ironmaking and steelmaking process. In practice this means it can be present up to about 0.005 wt. %, and more preferably up to about 0.003 wt. %.

The steel strip may have optionally one or more elements selected from the group consisting of: (Cr: up to 0.25 wt. %, Mo: up to 0.10 wt. %, V: up to 0.30 wt. %, Cu: up to 0.20 wt. %, Ni: up to 0.50 wt. %, and B: up to 0.005 wt. %).

Cr increases the hardenability of the steel and can be added to the steel strip in an amount of up to about 0.25 wt. %, and preferably up to about 0.10 wt. %, as it also can impair corrosion performance of the uncoated steel strip substrate. In a most preferred embodiment Cr is not purposively added and only present as an inevitable impurity resulting from the ironmaking and steelmaking process.

The steel strip may have Mo up to 0.10 wt. % to achieve hardenability. Furthermore, the presence of Mo may improve also the weldability of the steel strip and may contribute to precipitation strengthening as Mo—as carbide-forming element—can promote composite carbide precipitates in combination with Nb, Ti, and/or V.

Since Mo is an expensive alloy element, in another preferred embodiment the steel strip has Mo as a tolerable impurity element. In practice this means it can be present up to about 0.050 wt. %, more preferably up to about 0.03 wt. %, and most preferably up to about 0.01 wt. %.

Copper, when present, may increase the strength of the steel strip by both solid solution strengthening as well as precipitation hardening through copper precipitates. However, the Cu content should not exceed about 0.20 wt. % as a too high level of Cu can promote hot shortness that can occur during hot working of the steel strip, which leads to embrittlement of the steel. In an embodiment the Cu is not added as a purposive alloying element and can be present up to about 0.10 wt. %, more preferably up to about 0.05 wt. %, and most preferably up to about 0.03 wt. %.

Nickel up to about 0.50 wt. %, and preferably up to about 0.30 wt. %, increases the impact toughness and counters any hot shortness that can occur during hot working of the steel strip due to the presence of copper. In an embodiment Ni is not added as a purposive alloying element and can be present up to about 0.10 wt. %, more preferably up to about 0.05 wt. %, and most preferably up to about 0.03 wt. %.

Boron is not required to obtain the desired balance of properties of the steel strip, but can be present up to about 0.005 wt. %, thus up to 50 ppm, preferably up to about 0.0030 wt. %

(30 ppm), and most preferably up to about 0.0025 wt. % (25 ppm). B is very effective to enhance the hardenability of the steel, which means that lower cooling rates can be used on the run-out table. In an embodiment the B content is at least 0.0010 wt. % (10 ppm) and at most 0.0030 wt. % (30 ppm).

Vanadium can be present in the steel up to an amount of about 0.30 wt. %, and preferably up to about 0.20 wt. %, more preferably up to about 0.17 wt. %, and most preferably up to about 0.10 wt. %. However, V is a relatively costly alloying element that is mostly used to replace Ti for its precipitation strengthening effect and to avoid cementite formation by forming vanadium carbides or composite carbide precipitates with Nb, Ti, and/or Mo. In a preferred embodiment V is purposively added in an amount of at least about 0.05 wt. %, and more preferably of at least 0.08 wt. %. The combined addition of Ti and V is favoured as Ti offers a catalytic effect for V precipitation, making V precipitation more effective. Furthermore, V has no substantial effect on the non-recrystallisation temperature Tnr and hence does not promote anisotropy as Nb and Ti can do via their effect on Tnr. Since a reduced degree of anisotropy is beneficial for hole-expansion capacity a combined addition of Ti and V can be beneficial.

Furthermore, it has been found that cementite formation can be suppressed and the favourable formation of a small fraction of martensite plus retained austenite in the microstructure can be better controlled if the amount of and carbide-forming elements Ti, Nb, V, and Mo represented in wt. % satisfy the equation of:

$$1.8 \leq \frac{( C / 12 )}{( Ti\_sol / 48 + Nb / 93 + V / 51 + Mo / 96} \leq 5.8$$

with Ti_sol defined as the amount of free Ti in solution and expressed as:

$${Ti}_{sol} = Ti - ( \frac{48}{14} ) \times N$$

with the amount of Ti and N expressed in wt. %. Preferably, the lower limit of this equation is 2.0, more preferably 2.2, and most preferably 2.4. In an embodiment the upper limit is preferably 5.0, more preferably 4.0, and most preferably 3.8, to further suppress the presence of cementite and/or to control the amount of martensite.

In an embodiment the steel strip has a composition consisting of, in wt. %, C: 0.06-0.12 wt. %, Mn: 1.20-2.20 wt. %, Ti: 0.07-0.15 wt. %, Si: up to 0.65 wt. %, Al: up to 0.10 wt. %, P: up to 0.02 wt. %, S: up to 0.01 wt. %, Nb: up to 0.03 wt. %, N: up to 0.01 wt. %, and optionally one or more elements selected from the group consisting of: (Cr: up to 0.25 wt. %, Mo: up to 0.10 wt. %, V: up to 0.30 wt. %, Cu: up to 0.20 wt. %, Ni: up to 0.50 wt. %, B: up to 0.005 wt. %), and the balance Fe and inevitable impurities resulting from the ironmaking and steelmaking process, and with more preferred ranges as herein described and claimed.

The 0.2% offset proof strength or yield strength (Rp0.2), ultimate tensile strength (Rm), uniform elongation (Ag) and tensile elongation (A50) were determined from quasistatic (strain rate 3×10⁻⁴ s¹) tensile tests at room temperature with A50 specimen geometry with tensile testing parallel to the rolling direction according to EN 10002-1/150 6892-1. The geometry of the tensile specimens consisted in 50 mm gauge length in the rolling direction, 12.5 mm in width and a thickness depending on the final gauge. The strength of the steel at 0.2% offset strain is measured as the yield strength (Rp0.2 or YS).

The stretch-flangeability of the steel strip or the hole expansion capacity (HEC) was determined by hole expansion tests. Specimens of dimension 90 mm×90 mm×final thickness of the strip were cut from the as-coiled steel. A hole of 10 mm diameter was punched in the middle of the specimens, and the hole expansion tests were carried out according to ISO/TS 16630:2003(E) standard. Hole expansion testing of the samples was done with upper burring. A conical punch of 60° was pushed up from below and the hole diameter d_{f} was measured when a through-thickness crack formed. The hole expansion ratio A was calculated using the formula below with dₒ=10 mm:

$$λ = \frac{{d}_{f} - {d}_{0}}{{d}_{0}} \times 100 \%$$

For all the above mechanical tests, at least three specimens were tested for each condition and the average values are reported herein.

The average total crack length (ATCL) is used to assess the susceptibility of crack formation in situations similar to industrial applications. The ATCL parameter is determined in common laboratory cylindrical deep drawing tests on steel blanks, measuring 90 mm×90 mm, with the four corners of the square 10 mm cut in the direction of the two diagonals as shown in FIG. 1A. In the cylindrical deep drawing tests a punch, a draw die, and a blank holder is used. In this procedure the punch has a 50 mm diameter with a punch radius of 7 mm. The die has an inner diameter of 62 mm and a radius of 8 mm. This set up is shown schematically in FIG. 1B. The inner diameter is large enough to allow free movement of the edge of the formed cup. The clearance, i.e., the distance between the punch wall and die wall is 6 mm. The blank holder force is set at 50 kN. During the initial stage of the cylindrical deep drawing test and the deep drawing of a cup (FIG. 1C), four regions at the edge of the blank are plastically deformed due to high local compressive stresses during drawing (FIG. 1D). This results in local wrinkling of the edge. At the end of the test and upon release of the blank holder force, the four compressed regions are subjected to reverse loading due to spring back as these regions of the formed cylindrical cup start to lose contact with the blank holder. This reverse loading due to spring back may lead to the nucleation and growth of cracks in the four compressed and wrinkled regions of the drawn cup (see for example FIG. 1E). Cracks may either be through the full thickness of the steel strip and visible at both sides, i.e., inner and outside, of the drawn cup or only visible at one of both sides of the cup. The length of all visible cracks on the inside and outside of the four compressed edges (as illustrated in FIG. 1D) of the deep-drawn cup is measured using a magnifying glass of 10× equipped with a scale grid. The sum of the length of all observable cracks on the inside and outside of the cup wall is averaged over three of four drawn cups and reported as the average total crack length (ATCL) and expressed in mm.

Further, the work of fracture (WOF) is determined by compressing the formed cups between a cone and flat tool, the normal of the flat plane and the axis of the cone being parallel. The cone has an angle of 90° and touches the inner wall of the cup. As the flat tool moves towards the cone it exerts a normal force on the flat bottom of the cup. The cone exerts forces on the wall of the cup resulting in crack growing from the four regions of compressed edges of the cup. The tools are placed in a conventional tensile testing machine. The normal force on the flat plate is recorded as a function of the plate displacement. The test stops a few mm before the flat bottom of the cup touches the top of the cone. For the selected geometry displacement up to 12 mm can be recorded. The area under the force vs. displacement graph was calculated up to 10 mm displacement. The calculated value in Joules (kN mm or J) is an estimate of the material resistance to crack propagation and/or initiation and the work of fracture (WOF) is defined here as the area below the force-displacement curve up to a displacement of 10 mm.

Evidence of splitting has been determined by shearing the steel with a clearance of circa 12% and visual inspection of the sheared-edge quality based on the naked eye. A split is the result of delamination upon shearing leading to one or more cracks or splits in the fractured zone of the sheared edge. Upon inspection of the sheared edge, these splits manifest themselves as small fractures running on the one hand parallel to the sheet surface (and perpendicular to the movement of the shearing device during shearing) and into the material, running largely parallel to the lines of deformation in the shear-affected zone (SAZ) induced by shearing.

The X-ray random intensity ratios of the various texture components and fibres in the φ2=45° section of Euler space or a so-called Orientation Distribution Function (ODF) plot were measured as follows. Three incomplete pole figures (110, 200, 211) were recorded in a range of 0°<α<90° on a fully automated Bruker D8 diffractometer (CoKₐ-radiation and primary graphite monochromator) equipped with a 2D area detector (GADDS). An area of 8 mm² was scanned in reflection mode. The samples were grounded/polished to mid thickness or 1/2T, with T corresponding with the sample thickness. The surface was etched in a solution of 83 ml H₂O, 330 ml H₂O, 8 ml Ethyline Glycolmonobutylether, and 578 ml H₃PO₄ for 15 minutes to remove any deformation from the grinding/polishing steps prior to the texture measurements. The C-values required to generate textural data (e.g., Orientation Distribution Functions or in short ODF's) were acquired using Bruker TexEval software (version 2.4.0.4) using a triclinic sample symmetry. The ODF's were generated with an orthorombic sample symmetry in combination with Van Houtte routines and an in-house developed software routine (T2F, version 2006-36.1).

The microstructure of the steel strip was analysed by means of Electron Back Scatter Diffraction (EBSD), a technique well known in the art, which in turn also allows the quantification of the area or volume fraction of the various components. The EBSD measurements were conducted on cross sections parallel to the rolling direction (RD-ND plane) mounted in a conductive resin and mechanically polished to 1 μm. To obtain a fully deformation free surface, the final polishing step was conducted with colloidal silica (OPS).

The Scanning Electron Microscope (SEM) used for the EBSD measurements is a Zeiss Ultra 55 machine equipped with a Field Emission Gun (FEG-SEM) and an EDAX PEGASUS XM 4 HIKARI EBSD system. EBSD scans were collected on the RD-ND plane of the sheets at quarter-thickness. The samples were placed under a 70° angle in the SEM. The acceleration voltage was 15 kV with the high current option switched on. A 120 μm aperture was used and the typically working distance was 17 mm during scanning. To compensate for the high tilt angle of the sample, the dynamic focus correction was used during scanning.

The EBSD scans were captured using the TexSEM Laboratories (TSL) software: “Orientation Imaging Microscopy (OIM) Data Collection version 7.2”. Typically, the following data collection settings were used: Hikari camera at 5×5 binning combined with background subtraction (standard mode). The scan area was in all cases located at a position of ¼ the sample thickness and care was taken to avoid as much as possible to include non-metallic inclusions in the scan area. The EBSD scan size was in all cases 100×100 μm, with a step size of 0.1 μm, and a scan rate of approximately 100 frames per second. Fe(α) and Fe(γ) was used to index the Kikuchi patterns. The Hough settings used during data collections were: Binned pattern size of circa 96; theta set size of 1; rho fraction of circa 90; maximum peak count of 10; minimum peak count of 5; Hough type set to classic; Hough resolution set to low; butterfly convolution mask of 9×9; peak symmetry of 0.5; minimum peak magnitude of 10; maximum peak distance of 20.

The EBSD scans were evaluated with TSL OIM Analysis software version “8.0×64 [12-14-16]”. Typically, the data sets were 90° rotated over the RD axis to get the scans in the proper orientation with respect to the measurement orientation. A standard grain dilation clean-up was performed (Grain Tolerance Angle (GTA) of 5°, a minimum grain size of 5 pixels, criterion used that a grain must contain multiple rows for a single dilation iteration clean-up). Next to this, a pseudo-symmetry clean-up (GTA 5, axis ang 30°@111) was applied.

From the EBSD scans on a 100×100 mm area (0.01 mm²) on the RD-ND plane at ¼-thickness, the average grain size by number based on a grain tolerance angle of 15° (GS_{N15}) was measured. For these scans, also the sum (ΣGB) of the total grain boundary length of grain boundaries (in mm) with misorientation angles of 15° to 65° (ΣGB₁₅₋₆₅) was measured. The value of ΣGB₁₅₋₆₅ is expressed in mm⁻¹ (or 1/mm) and is a measure for the density of high-angle grain boundaries.

The MisOrientation angle Distribution (MOD) index of the Fe(α) partition was calculated using the following method: the normalised misorientation angle distribution (MOD), including all boundaries, ranging from misorientation angles of 5° to 65° with a binning of 1°, was calculated from the partitioned EBSD data set using the TSL OIM Analysis software. Similarly, the normalised theoretically MOD of randomly recrystallized polygonal ferrite was calculated with the same misorientation angle range and binning as the measured curve. In practice this is the so-called “Mackenzie” based MOD included in the TSL OIM Analysis software. Normalisation of the MOD means that the area below the MOD is defined as 1. The MOD index is then defined as the area between the theoretical curve (the dashed line) and the measured curve (the solid line) in FIG. 2A and FIG. 2B and can be written as:

$$MOD index = {\sum }_{i = 5}^{65} \vert {R}_{MOD , i} - {M}_{MOD , i} \vert$$

with M_{MOD,i} as the intensity at angle i (ranging from 5° to 65°) of the measured MOD and R_{MOD,i} as the intensity at angle i of the theoretical or “Mackenzie” based MOD of randomly recrystallized polygonal ferrite.

The solid line in FIG. 2A and 2B represents the measured MOD and the dashed curve represents the theoretical misorientation angle curve for a randomly recrystallized polygonal ferrite structure. FIG. 2A shows a MOD curve for an exemplary sample with a microstructure having a predominantly polygonal ferrite character. FIG. 2B shows a MOD curve of an exemplary sample with a microstructure having a predominantly acicular/bainitic or bainitic character. The MOD index ranges by definition from 0 to almost 2; when the measured curve is equal to the theoretical curve, the areas between the two curves is 0 (MOD index will be 0), whereas if there is (almost) no intensity overlap between the two distribution curves, the MOD index is (almost) 2. So, as illustrated in FIG. 2A and FIG. 2B, the MOD contains information on the nature of the microstructure and the MOD index can be used to assess the character of a microstructure based on a quantitative and hence more unambiguous approach than based on conventional methods such as light-optical microscopy. A fully polygonal ferrite microstructure will have a unimodal MOD with most of the intensity in the 20° to 50° range and a peak intensity around 45°. In contrast, a fully acicular/bainitic ferrite or bainitic microstructure will have a strong bimodal MOD with peak intensities in between 5° to 10° and 50° to 60° and little intensity in the range of 20° to 50°. Hence, a low MOD index and a high 20° to 50° MOD intensity in the present example is a clear signature of a predominantly polygonal ferrite microstructure, whereas a high MOD index and a low 20° to 50° MOD intensity is a clear signature of a predominantly acicular/bainitic ferrite or bainitic microstructure. Inventors found that a MOD index above 0.65 corresponds with a acicular/bainitic ferrite or bainitic microstructure with the alloy compositions and process settings as used in the example to describe the invention.

In an aspect of the invention it relates to a method of manufacturing a hot-rolled high-strength steel strip as herein described and claimed, the method comprising the steps of, in that order,
casting a slab, followed by the step of reheating the solidified slab to a temperature between 1050-1260° C., preferably holding the slab at a temperature between 1050° C. and 1260° C. for a time of about 20-60 minutes, and hot rolling said slab, or casting a slab or strip followed by the step of hot rolling said slab or strip;
hot rolling the steel slab or strip and finishing said hot rolling at a finish rolling temperature (FRT) between 960° C. and Ar₃+20° C., preferably between 960° C. and 900° C., and most preferably between 960° C. and 920° C., and where Ar₃ is the temperature at which transformation of austenite to ferrite starts during cooling. As known in the art the Ar₃ temperature can be calculated according to the following equation:

$${Ar}_{3} = 910 ° C . - 203 {x [ C ]}^{1 / 2} + 44.7 x [ Si ] + 400 [ A l ] + 700 [ P ] - 30 x [ Mn ] + 31 \text{.5} x [ Mo ] - 11 [ Cr ] + 400 x [ Ti ] + 104 x [ V ] ;$$

This equation shows that carbon suppresses the Ar₃ austenite-to-ferrite phase transformation, which will promote grain refinement. Furthermore, it shows that also Mn suppresses the Ar₃ transformation temperature.
accelerated cooling of the hot-rolled steel strip with a run-out table primary cooling rate (CR1) between 50-150° C./s, preferably between 65-100° C./s, and most preferably between 70-80° C./s, to an intermediate temperature on the run-out table (IT_{ROT}) between 500-600° C., preferably between 520-590° C., and more preferably between 540-580° C.;
further accelerated cooling of the hot-rolled steel strip with a run-out table secondary cooling rate (CR2) of between 1 and 30° C./s, or preferably between 5-25° C./s, to a coiling temperature between 450-580° C., preferably between 475-560° C.;
coiling the hot-rolled and cooled steel strip at a coiling temperature (CT) between 450-580° C., and preferably between about 475-560° C.;
allowing the coiled hot-rolled steel strip to further cool to ambient temperature;
optionally pickling the hot-rolled steel strip; and
optionally providing the hot-rolled steel strip with a metallic coating layer, preferably selected from the group comprising: a Zn-layer, Zn-based alloy layer, Mg-based alloy layer, or an Al-based alloy layer, to provide improved corrosion resistance in service. The metallic coating layer is preferably applied by means of heat-to-coat or hot-dip coating, and may also be applied via electrolytic deposition.

The method of manufacturing herein described and claimed result in the desired microstructure providing for the aimed improved balance of high edge ductility as expressed by hole-expansion capacity with adequate toughness and good shearing performance with substantially no splitting for a hot-rolled deep-drawable sheet strip with a yield strength ranging from 600 to 820 MPa, a tensile strength ranging between 730 to 950 MPa, and a A50 tensile elongation of 11% or higher. The invention is also embodied in a steel strip manufactured by the method described herein and claimed having said composition, microstructure and improved balance of toughness, shearing performance and mechanical properties.

The invention is not limited by the casting method. The steel can be cast as a conventional thick-slab having a cast thickness of between 150-350 mm, and typically of 225-250 mm, as well as a thin-slab having a cast thickness of between 50-150 mm in a direct strip plant. For conventional thick-slab casting, reheating of the slab is necessary to reheat the slab from ambient temperatures (usually the thick cast slabs have cooled down from the casting temperature to ambient temperatures in a slab yard) and to homogenise the slab with respect to composition, and therefore the reheating temperature should be above about 1050° C. also to dissolve any precipitates when micro-alloying elements are present and to bring the slab to such a temperature that the final hot rolling in the finishing mill can still be performed above 960° C. Often this requires a (slab) reheating temperature of between about 1050 to 1260° C. For thin-slab casting the cast slab is subjected to a homogenisation treatment in a homogenising furnace immediately after casting the thin slab wherein the homogenisation temperature should be above about 1050° C., and is typically about 1100 to 1160° C. This would also prevent any precipitates from forming when micro-alloying elements, if any, are present and also bring the thin slab to such a temperature that the final hot rolling in the finishing mill can still be performed at FRT>Ar₃+20° C. According to the invention the reheating or the homogenisation time for the thin slab casting route is preferably 20 minutes or more.

The hot rolling of the steel must be carried out in the austenitic phase to control the final microstructure. On an industrial scale of rolling the FRT should be kept above the Ar₃ temperature. In a preferred embodiment the above Ar₃+20° C., e.g. typically above about 890° C., to avoid hot rolling locally below Ar₃ at colder edges or the tail of the strip. However, the FRT should not be too high in the austenite region as that will lead to insufficient grain refinement (too high GS_{N15}) and too few high-angle grain boundaries (to low ΣGB₁₅₋₆₅), which can ultimately lead to too low fracture toughness and hence a too high average total crack length and too low work of fracture. Furthermore, a too high FRT, will promote an unfavourable texture (e.g., the {001}<110> rotated Cube on the θ-fibre and {110}<001> Goss) in relation fracture toughness, embrittlement, and delamination and subsequently result in increased edge crack sensitivity and increased susceptibility to splitting upon shearing. For that reason FRT should not exceed 960° C. A relatively low FRT is beneficial to promote sufficient grain refinement and to promote texture components that are beneficial for fracture toughness, such as the {554}<225> and—in particular—{332}<113>. On the other hand, a too low FRT, next to avoiding hot rolling locally below Ar₃ at colder edges or the tail of the strip, a too low FRT can stimulate too much the intensity of the texture components of the α*-segment of the α-fibre as well as the {112}<332>, which are associated with increased anisotropy (in particular the {113}<110> and {112}<110> on the α*-segment). A too high degree of anisotropy increases the planar anisotropy (increased variation in r-value), which can reduce the drawability of the steel and impair its hole-expansion capacity. Hence the FRT should not be too low and be above (Ar₃+20° C.), preferably above 900° C., and more preferably above 920° C. The considerations given here above illustrate the relevance and complexity of the FRT in terms of control of the final microstructure and its texture in relation to obtaining the right balance between fracture toughness and hole-expansion capacity and reducing the risk of splitting upon shearing.

After hot rolling, the steel strip is accelerated cooled on a run-out table (ROT) to an intermediate temperature on the ROT (IT_{ROT}) between 500-600° C., preferably between 520-590° C., and most preferably between 540-580° C., and with a run-out table primary cooling rate (CR1) between 50-150° C./s, preferably between 65-100° C./s, and more preferably between 70-80° C./s. This is achievable through air cooling, laminar cooling or water jet cooling depending on the thickness of the steel strip. An accelerated cooling rate is desired to suppress recovery and loss of internal stored energy in the austenite in order to promote grain refinement (small GS_{N15}) of the final microstructure and increased ΣGB₁₅₋₆₅. The cooling rate should be high enough to avoid austenite-to-ferrite phase transformation at elevated temperatures (potentially leading to a too low MOD index) and to preferably promote austenite-to-ferrite phase transformation at relatively low temperatures of about 560-630° C. on the run-out-table promoting a high MOD index≥0.85. Increased cooling rate will promote grain refinement (decreased GS_{N15}), increased ΣGB₁₅₋₆₅ and hence increased fracture toughness and reduced crack susceptibility. Increased cooling rate will also suppress texture randomisation and hence suppress the loss in intensity of those textures developed from deformed austenite that promote toughness (e.g., {332}<113>) and suppress those that are associated with embrittlement and delamination (e.g., {001}<110> rotated Cube). An unnecessarily high CR1 may affect the flatness of the strip after cooling and can cause control problems to stop at the correct cooling stop temperature and therefore a suitable maximum CR1 is about 150° C./s, or preferably about 100° C./s, or most preferably about 80° C./s. For practical reasons the run-out table cooling rate (ROT-CR) is defined as the average cooling rate of the surface of the steel strip.

Next, the hot-rolled steel strip at a temperature (IT_{ROT}) between 500-600° C., preferably between 520-590° C., and more preferably between 540-580° C., is actively cooled to a coiling temperature between 450-580° C., or preferably between 475-560° C., with a run-out table secondary cooling rate (CR2) of about 1 to 30° C./s. In a preferred embodiment the CR2 is in a range of about 5-25° C./s. Further, the hot-rolled steel strip is coiled at a temperature between about 450-580° C., and preferably between 475-560° C. Next to the finish rolling temperature, the coiling temperature of the steel strip is a key process parameter to arrive at the required microstructure of the hot-rolled steel strip providing for the improved balance in properties as herein described.

When the coiling temperature is too low there is insufficient kinetics for precipitation and consequently low strength levels will be achieved. When the coiling temperature is too high there is insufficient grain refinement leading to reduced fracture toughness and increased edge-crack susceptibility. A too high coiling temperature will also reduce the MOD index, which can impair hole-expansion capacity and promote splitting upon shearing. During coil cooling further precipitation may take place, as well as some further phase transformation. Undesirably, precipitates once formed may coarsen during coil cooling. The alloy composition in combination with the claimed coiling temperature range suppresses this phenomenon. This coiling temperature will help to promote small grains of ferrite formed during cooling on the run-out-table, coiling, or coil cooling, and furthermore suppress coarsening of precipitates that strengthen the ferrite matrix, which can be beneficial to improve sheared-edge quality and to suppress delamination or splitting upon shearing.

In a preferred embodiment the fraction transformed from austenite to acicular/bainitic ferrite and/or bainite at the end of the run-out-table and prior to coiling (CTzm) is at least 48%, preferably at least 50%, most preferably at least 52%. An increased fraction transformed from austenite to acicular/bainitic ferrite and/or bainite results from a faster rate of phase transformation on the run-out-table prior to coiling and yields increased grain refinement, which is beneficial for improved fracture toughness in terms of reduced average total crack length (ATCL) and increased work of fracture (WOF).

In patent document EP1616970-A1 it is disclosed that a holding temperature below 680° C. leads to insufficient driving force for ferrite transformation and subsequent a too low fraction ferrite containing precipitates. For the present invention, the austenite-to-ferrite phase transformation is enforced at a temperature range below 680° C. in order to achieve increased grain refinement and increased ΣGB₁₅₋₆₅ for improved fracture toughness and reduced crack susceptibility, while still having sufficient kinetics for precipitation. Furthermore, patent document EP1616970-A1 discloses that after holding the steel strip longer than 1 sec at a temperature of 680° C. or above, it is necessary to apply secondary cooling to a coiling temperature of 550° C. or below, preferably 450° C. or below, and more preferably 350° C. or below at an average cooling rate of 30° C./s or more, preferably 50° C./s or more, and coiling in order to form the secondary phase of bainite and/or martensite and to suppress the formation of other phase at 5 vol. % or less. For the present invention, the coiling temperature is considerably higher with values between 450-580° C., and preferably between 475-560° C., in order to allow the austenite-to-ferrite phase transformation to continue at relatively low temperatures to promote fine-grained acicular/bainitic ferrite and/or bainite, which is precipitation strengthened with carbide precipitates comprising Ti, and optionally Mo, Nb, and/or V. The grain refinement and increased ΣGB₁₅₋₆₅ provides for improved fracture toughness and reduced (edge) crack susceptibility. Coiling below 450° C. will lead to insufficient acicular/bainitic ferrite and/or bainite formation and loss in precipitation strengthening. Furthermore, it may lead to too high a martensite fraction.

Though patent document EP1338665-A1 discloses a coiling temperature in the range of 550-700° C., the steels produced having a tensile strength of at least 950 MPa and a hole-expansion capacity of at least 40%, were all produced with coiling temperatures exceeding 600° C. The finish rolling temperatures for all these steels were in the range of 880-930° C. In accordance with the present invention it has been found that too high a coiling temperature leads amongst others to increased crack susceptibility, in particular edge-crack susceptibility, and also reduced fracture toughness.

After the steel strip has cooled to room temperature, the oxides (scale) on the hot-rolled steel strips are removed either by pickling in an acid solution (e.g., HCl) at warm temperatures (about 80-120° C.) or by a combination of pickling and mechanical brushing of the strip surface. This step is necessary for rendering the steel strip surface suitable for direct use as uncoated hot-rolled steel or making it amenable to the coating process, when optionally needed for corrosion resistance.

In an embodiment the thickness of the high-strength hot-rolled steel strip is in a range of about 1.5 to 8 mm, and more preferably of about 1.8 to 6 mm, and most preferably of about 1.8 to 4.5 mm.

It is an important aspect of the invention that the hot-rolled steel strip is not subsequently subjected to a cold rolling operation having a thickness reduction of more than 1.6%.

The high-strength hot-rolled steel strip product can be a bare product or uncoated product or it can be provided on one or both of its main surfaces with a thin metallic coating layer, typically up to about 100 g/m² per side of the steel strip, and preferably up to about 50 g/m² per side. The metallic coating is preferably selected from the group comprising an aluminium alloy coating (e.g., an Al—Si alloy, or Al—Zn alloy), a zinc coating, and a zinc alloy coating (e.g., a Zn—Al alloy, Zn—Mg alloy, Zn—Fe alloy, Zn—Al—Mg alloy, or Zn—Mg—Al alloy).

The composition of the zinc or zinc alloy coating layer is not limited. Although the coating layer can be applied in various ways, hot-dip galvanising is preferred using a standard GI coating bath. The Zn based coating layer may comprise a Zn alloy containing Al as an alloying element. A preferred zinc bath composition contains about 0.10-0.35 wt. % Al, the remainder being zinc and unavoidable impurities.

Other zinc coating layers may also be applied. An example comprises a zinc alloy coating according to patent document WO2008/102009-A1 and incorporated herein by reference, in particular a zinc alloy coating layer consisting of about 0.3-4.0 wt. % Mg and about 0.05-6.0 wt. % Al, preferably about 0.1-5.0% Al, and optionally at most about 0.2 wt. % of one or more additional elements along with unavoidable impurities and the remainder being zinc. A preferred Zn bath comprising Mg and Al as main alloying elements has the composition: about 0.5-3.8wt. % Al, about 0.5-3.0 wt. % Mg, optionally at most 0.2 wt. % of one or more additional elements; the balance being zinc and unavoidable impurities. An additional element typically added in a small amount of less than 0.2 wt. %, could be selected from the group comprising Pb, Sb, Ti, Ca, Mn, Sn, La, Ce, Cr, Ni, Zr, and Bi. Pb, Sn, Bi, and Sb are usually added to form spangles. Preferably, the total amount of additional elements in the zinc alloy is at most 0.2 wt. %, and more preferably at most 0.1 wt. %. These small amounts of an additional element do not alter the properties of the coating nor the bath to any significant extent for the usual applications. Preferably, when one or more additional elements are present in the coating, each is present in an amount up to 0.02 wt. %, preferably each is present in an amount up to 0.01 wt. %. Additional elements are usually only added to prevent dross forming in the bath with molten zinc alloy for the hot-dip galvanising, or to form spangles in the coating layer.

In another embodiment the metallic coating comprises a (commercially pure) aluminium layer or an aluminium alloy layer. A typical metal bath for hot-dip coating such an aluminium layer comprises aluminium alloyed with silicon e.g. aluminium alloyed with about 8-11 wt. % of silicon and at most about 4 wt. % of iron, optionally at most 0.2 wt. % of one or more additional elements such as calcium, unavoidable impurities, the remainder being aluminium. Silicon is present in order to prevent the formation of a thick iron-metallic intermetallic layer which reduces adherence and formability. Iron is preferably present in amounts between about 1 and 4 wt. %, more preferably at about least 2 wt. %.

In an aspect of the invention it relates to a galvanized steel strip obtained by hot dip galvanizing the high-strength hot-rolled steel strip according to this invention.

In another aspect of the invention it relates to an automotive component, in particular an automotive chassis part, made from or incorporating the high-strength hot-rolled steel strip according to this invention and taking benefit from amongst others improved balance of strength, formability and the improved fracture toughness, high edge ductility, and reduced (edge-) crack susceptibility. The steel strip can be shaped into an automotive component in a cold forming operation, warm forming or hot forming operation as are known in the art. The automotive component includes, but is not limited to, a suspension arm, a reinforcement member, body-in-white frame member, as side member, a seat frame, a seat rail, bumper beam, battery boxes for electrical vehicles, all having an intricate shape. By using the hot-rolled high-strength steel strip, these components can be fabricated with high quality, cost efficiently and with high yields. The high-strength hot-rolled steel product according to this invention can be used also for engineering applications.

In yet another aspect of the invention it relates to an automotive chassis part using the hot-rolled high-strength steel strip according to and/or produced according to the invention, and wherein the hot-rolled high-strength steel strip for making the automotive chassis part either:
has an ultimate tensile strength ranging from 730-950 MPa, a hole-expansion ratio of at least 45%, preferably of at least 50%, and most preferably of at least 60%, a work of fracture (WOF) of at least 100 J, preferably of at least 125 J, and more preferably of at least 200 J, in which ultimate tensile strength (Rm), total tensile elongation (A50), and sheet thickness t (mm) satisfy the equation of (Rm×A50)/t^{0.2}≥8,000; or
has an ultimate tensile strength ranging from 730-950 MPa, a hole-expansion ratio of at least 45%, preferably of at least 50%, and most preferably of at least 60%, a work of fracture (WOF) of at least 100 J, preferably of at least 125 J, and more preferably of at least 200J, in which ultimate tensile strength (Rm), total tensile elongation (A50), and sheet thickness t (mm) satisfy the equation of (Rm×A50)/t^{0.2}≥9,000; or
has an ultimate tensile strength ranging from 730-950 MPa, a hole-expansion ratio of at least 45%, preferably of at least 50%, and most preferably of at least 60%, a work of fracture (WOF) of at least 100 J, preferably of at least 125 J, and more preferably of at least 200 J, and in which ultimate tensile strength (Rm), total tensile elongation (A50), and sheet thickness t (mm) satisfy the equation of (Rm×A50)/t^{0.2}≥10,000; or
has a yield strength (Rp0.2) ranging from 600-820 MPa, a yield ratio ranging from 0.8 to 0.9, and a hole-expansion ratio of at least 45%, preferably of at least 50%, and more preferably of at least 60%, a work of fracture (WOF) of at least 100 J, preferably of at least 125 J, and more preferably of at least 200 J, and in which ultimate tensile strength

(Rm), total elongation (A50), and sheet thickness t (mm) satisfy the equation of (Rm×A50)/t^{0.2}≥10,000.

### DESCRIPTION OF THE FIGURES

The invention shall also be described with reference to the appended non-limiting figures, in which:

FIG. 1A to FIG. 1E show several features of the method to determine to average total crack length (ATCL) and work of fracture (WOF) of a steel strip product using common cylindrical deep drawing tests for drawing cups.

FIG. 2A and FIG. 2B show examples of MisOrientation Distribution (MOD) profiles used to explain the physical meaning and definition of the MOD index to characterise the matrix of the microstructure in a quantitative manner.

FIG. 3 shows a schematic φ2=45° section of Euler space or Orientation Distribution Function (ODF), featuring the relevant texture fibres, segments, and components to clarify the relationship between texture and hole-expansion capacity and occurrence of splitting that inventors have found.

FIG. 4 shows the work of fracture (WOF) against the hole-expansion capacity (HEC) for inventive examples 1A-4A and 6A and comparative examples 5A and 7A-13A.

FIG. 5 shows the work of fracture (WOF) against the high-angle grain boundary density (ΣGBL₁₅₋₆₅) for inventive examples 1A-4A and 6A and comparative examples 5A and 7A-13A.

FIG. 6 shows the work of fracture (WOF) against the average grain size by number based on a grain tolerance angle of 15° (GS_{N15}) for inventive examples 1A-4A and 6A and comparative examples 5A and 7A-13A.

FIG. 7 shows the average total crack length (ATCL) against the high-angle grain boundary density (ΣGBL₁₅₋₆₅) for inventive examples 1A-4A and 6A and comparative examples 5A and 7A-13A.

FIG. 8 shows the average total crack length (ATCL) against the average grain size by number based on a grain tolerance angle of 15° (GS_{N15}) for inventive examples 1A-4A and 6A and comparative examples 5A and 7A-13A.

FIG. 9 shows the hole-expansion capacity (HEC) against the T factor for inventive examples 1A-4A and 6A and comparative examples 5A, 7B, 8B, 10B, and 11B without splits upon shearing and comparative examples 9B, 12B, and 13B with splits upon shearing.

FIG. 10 shows the high-angle grain boundary density (ΣGBL₁₅₋₆₅) against the T factor for inventive examples 1A-4A and 6A and comparative examples 5A, 7B, 8B, 10B, and 11B without splits upon shearing and comparative examples 9B, 12B, and 13B with splits upon shearing.

FIG. 11 shows the average grain size by number based on a grain tolerance angle of 15° (GS_{N15}) against the T factor for inventive examples 1A-4A and 6A and comparative examples 5A, 7B, 8B, 10B, and 11B without splits upon shearing and comparative examples 9B, 12B, and 13B with splits upon shearing.

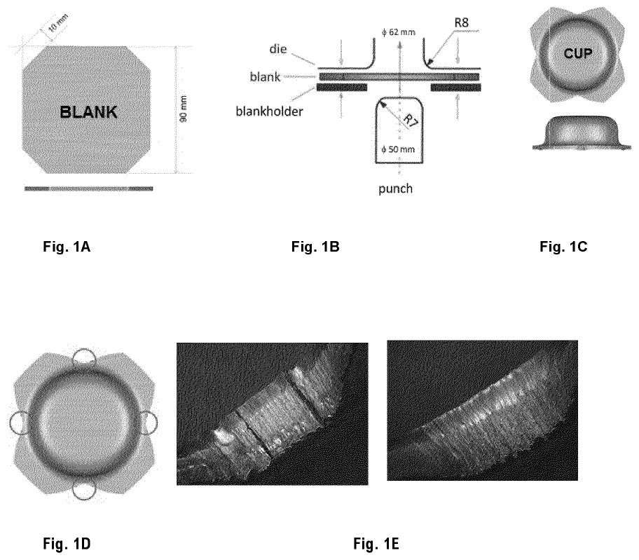

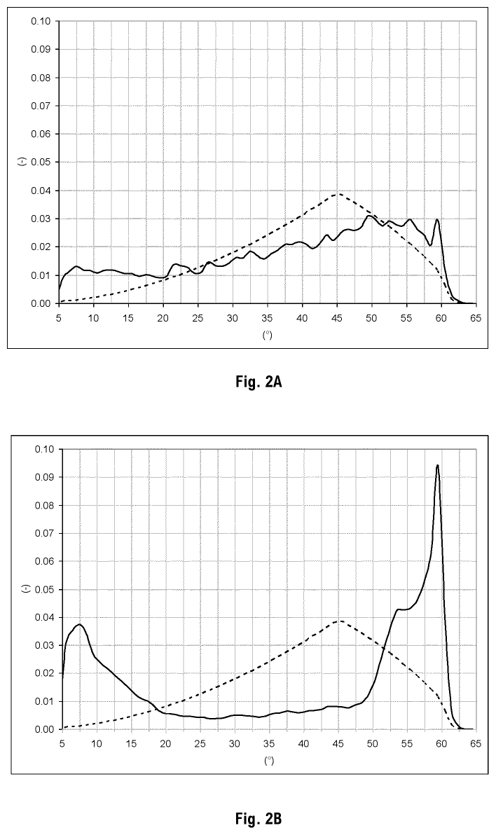

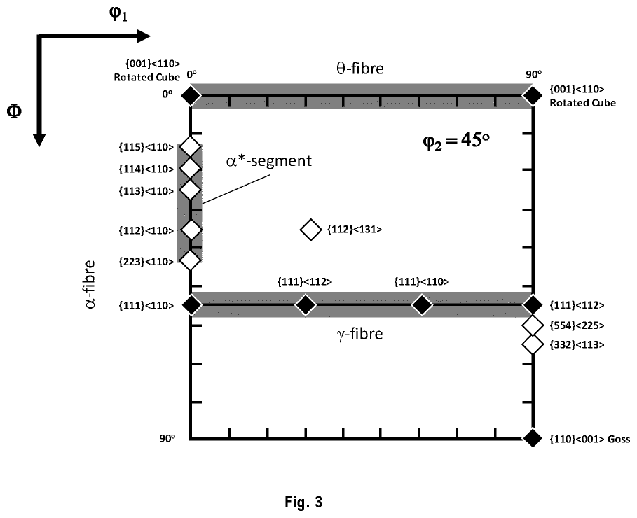

The invention will now be illustrated with reference to non-limiting comparative and examples according to the invention.

### EXAMPLES

### Example 1

Steel slabs of three chemistries A, B and C, wherein A and B are according to the invention and C is comparative were produced industrially via basic oxygen steelmaking and continuous casting. The chemical compositions of these steels are given in Table 1. To each of the steels A to C there has been no purposive addition of Cr, Mo, V, and Nb. In Table 1 also a is given whereby α is calculated using the formula:

$$α = \frac{( C / 12 )}{( Ti\_sol / 48 + Nb / 93 + V / 51 + Mo / 96}$$

$$with$$

$${Ti}_{sol} = Ti - ( \frac{48}{14} ) \times N$$

TABLE 1
Chemical composition of the steels, in wt. %. The balance is Fe and inevitable
impurities resulting from the ironmaking and steelmaking process. Alloy A is an
example according to the invention, and Alloy B and C are comparative examples.

| | Element | | | | | | | | | | | |
|---|---|---|---|---|---|---|---|---|---|---|---|---|
| Alloy | C | Mn | Si | P | S | Al | Ti | B | N | Ti—Sol | α | C/[Ti_sol + V] |
| A | 0.081 | 1.83 | 0.33 | 0.009 | 0.000 | 0.037 | 0.111 | 0.0002 | 0.0046 | 0.095 | 3.402 | 0.851 |
| B | 0.068 | 1.81 | 0.34 | 0.010 | 0.000 | 0.036 | 0.108 | 0.0021 | 0.0053 | 0.090 | 3.028 | 0.757 |
| C | 0.034 | 1.85 | 0.39 | 0.011 | 0.001 | 0.046 | 0.126 | 0.0021 | 0.0052 | 0.108 | 1.257 | 0.314 |

The slabs have been processed on an industrial scale and the relevant processing parameters used are given in Table 2. The fraction transformed from austenite to acicular/bainitic ferrite and/or bainite at the end of the run-out-table and prior to coiling (CTzm) was measured by means of real-time, online measurement using a detector that creates a primary magnetic field, which interacts with the hot-rolled steel strip passing by, leading to a secondary magnetic field. This magnetic response of the hot-rolled steel strip and the essential difference in magnetic permeability between austenite and ferrite is the essential principle to monitor the transformation of iron from austenite to ferrite as the steel cools on the run-out-table at specific locations. The fraction transformed from austenite to acicular/bainitic ferrite and/or bainite at the end of the run-out-table and prior to coiling (CTzm) is given in Table 2.

The mechanical properties (Rp, Rm, yield ratio, and A50), hole expansion capacity (HEC), average total crack length (ATCL), work of fracture (WOF), and assessment of splitting (Splits) in accordance with the methods herein described, as listed in Table 2 as function of the processing parameters applied.

The microstructural characteristics of the hot-rolled steels were determined with EBSD and the X-ray random intensity ratios of specific texture components, fibres, and segments were measured with XRD according to the methods as herein described. The microstructural characteristics and X-ray random intensity ratios are listed in Table 3. Also shown in Table 3 is the T factor, which is defined as the MOD index to the power 1.2 times the ratio of the sum of the X-ray random intensity ratios of the γ-fibre, θ-fibre, and {110}<001> Goss texture component divided by the sum of the X-ray random intensity ratios of the α*-segment, {112}<131>, {332}<113>, and {554}<225> texture components according to:

$$T = \frac{[ ( γ - fibre ) + ( θ - fibre ) + \{ 1 \; 10 \} < 001 > ]}{[ ( {α}^{*} - segment ) + \{ 1 \; 12 \} < 131 > + \{ 3 \; 32 \} < 113 > + \{ 5 \; 54 \} < 225 > ]} \times {MOD}^{1.2}$$

The α*-segment is here defined as the segment of the α-fibre in the φ2=45° section of Euler space or Orientation Distribution Function (ODF) running from the {115}<110> to the {223}<110> (and including the X-ray random intensity ratios of these outer two texture components), which covers the 15° to 45° range on the α-fibre. The relevant texture fibres, segments, and components are shown in FIG. 3 displaying a schematic φ2=45° section of Euler space or Orientation Distribution Function (ODF).

From the results of Tables 2 and 3 it can be seen that in order to produce a steel with a good balance between hole-expansion capacity and fracture toughness in terms of average total crack length (ATCL) and work of fracture (WOF) on the one hand and no splitting upon shearing on the other, it is essential to control the process in terms of the finish rolling temperature, thermal run-out-table cooling trajectory, and coiling temperature in order to promote a fine-grained acicular/bainitic ferrite and/or bainite microstructure with a sufficiently high misorientation distribution (MOD) index and sufficiently high-angle grain boundary density in combination with a suitable texture. Inventors have found that with a suitable combination of alloy composition and hot-rolling process with:
a finish rolling temperature (FRT) of at least 900° C. and at most 960° C.,
an intermediate temperature on the run-out-table (IT_{ROT}) of at least 500° C. and at most 600° C.,
a coiling temperature (CT) of at least 475° C. and at most 580° C., leading to a fraction transformed from austenite to acicular/bainitic ferrite and/or bainite at the end of the run-out-table and prior to coiling (CTzm) of at least 48%, a steel can be obtained, in accordance with inventive examples 1A-4A and 6A that deliver acicular/bainitic ferrite and/or bainite microstructures with:
a MOD index of at least 0.85,
an average grain size by number based on a grain tolerance angle of 15° (GS_{N15}) of at most 2.0 μm,
a high-angle grain boundary density (ΣGB₁₅₋₆₅) of at least 1060 mm⁻¹,
X-ray random intensity ratio of the γ-fibre of at least 27, and
a T factor of at least 1.1 and at most 1.8,
   that yield high-strength steels with a suitable hole-expansion capacity of at least 45% in combination with sufficient fracture toughness as expressed by an average total crack length

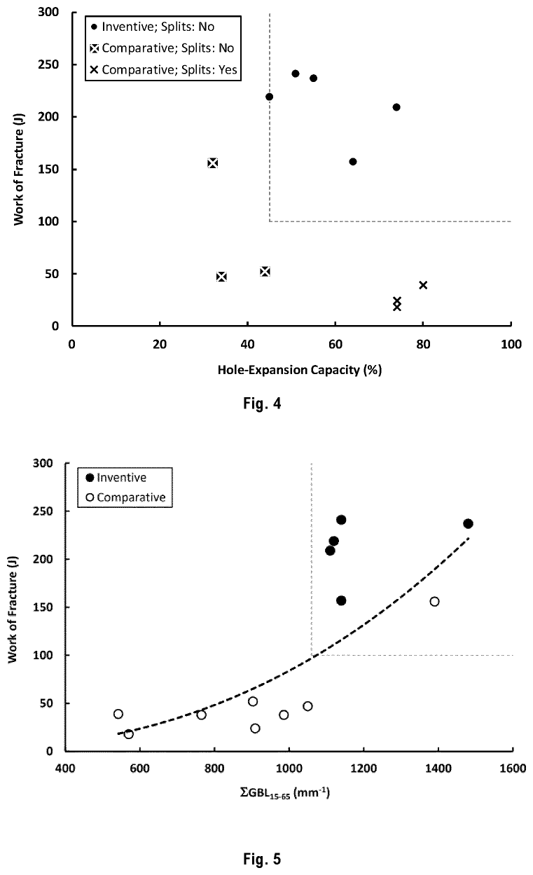

(ATCL) of at most 20 mm, a work of fracture (WOF) of at least 100 J, and no splitting upon shearing. FIG. 4 shows a plot of work of fracture (WOF) against hole-expansion capacity (HEC) for the inventive examples (with no splits) and the comparative examples with and without splits.

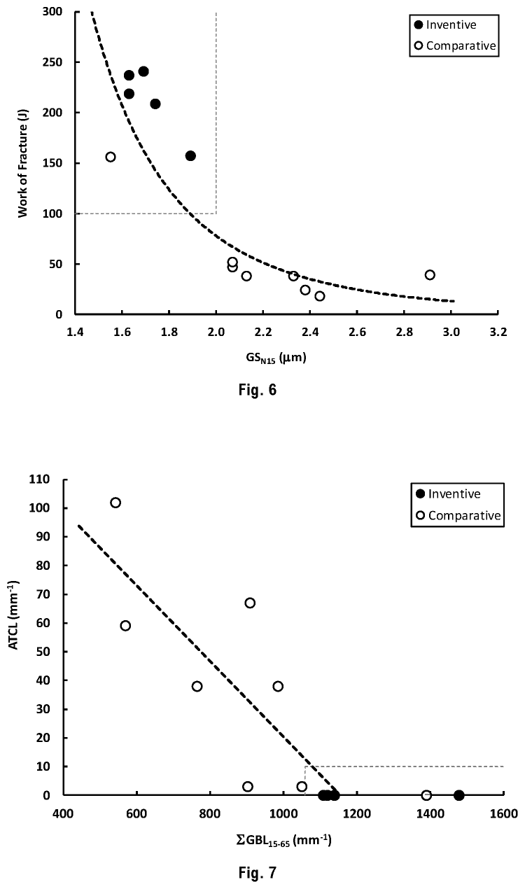

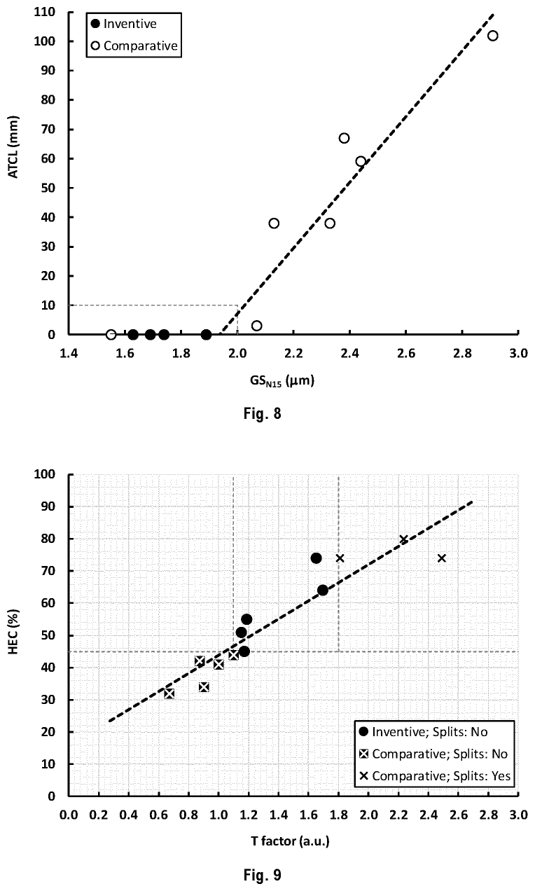

FIGS. 5 to 8 show the work of fracture (WOF) and average total crack length (ATCL) plotted against ΣGBL₁₅₋₆₅ and GS_{N15} for all examples, inventive and comparative, listed in Table 2. The data shows a strong correlation between work of fracture (WOF) and average total crack length (ATCL) and the average grain size and density of high-angle grain boundaries. Inventors found the following empirical relationships for the work of fracture (WOF) as a function of ΣGBL₁₅₋₆₅ and GS_{N15}:

$$WOF = 3 \times {16}^{6} \times {( \sum {GBL}_{15 - 16} )}^{2.47}$$

$$WOF = 1619.3 \times {( {GS}_{N 15} )}^{4.38}$$

The inventors found that the hole-expansion capacity is largely controlled by texture and the MOD index according to the empirical based on a linear fit of the data shown in FIG. 9 with the hole-expansion capacity plotted against the T factor according to:

$$HEC = 28.13 \times T + 15.78$$

and with:

$$T = \frac{[ ( γ - fibre ) + ( θ - fibre ) + \{ 1 \; 10 \} < 001 > ]}{[ ( {α}^{*} - segment ) + \{ 1 \; 12 \} < 131 > + \{ 3 \; 32 \} < 113 > + \{ 5 \; 54 \} < 225 > ]} \times {MOD}^{1.2}$$

This relationships shows that in order to have a hole-expansion capacity of at least 45% the T factor should be at least 1.1 as illustrated by FIG. 9, preferably at least 1.15 and more preferably at least 1.4. However, too high a T factor can promote splitting upon shearing as also illustrated by FIG. 9. Hence, the T factor should be at most 1.8 when GSN15 is too high and ΣGBL₁₅₋₆₅ too low. A high X-ray random intensity ratio of the γ-fibre is beneficial to promote deep drawability of steel and according to the above description of the T factor, also beneficial for hole-expansion capacity. The inventors have found that the X-ray random intensity ratio of the γ-fibre should be at least 27. Though beneficial for high hole-expansion capacity, too high a T factor can lead to splitting upon shearing as the X-ray random intensity ratios of the θ-fibre, comprising the {001}<110> rotated Cube texture component, and {110}<001> Goss texture, component, all connected to delamination and embrittlement, become too high and the X-ray random intensity ratios of the α*-segment and {112}<131> texture component, both connected with increased anisotropy, and {332}<113> and {554}<225>, connected both with increased toughness, become too low. Splitting upon shearing is not desired as it reduced the sheared-edge fatigue and can impair the in-service performance of structural components.

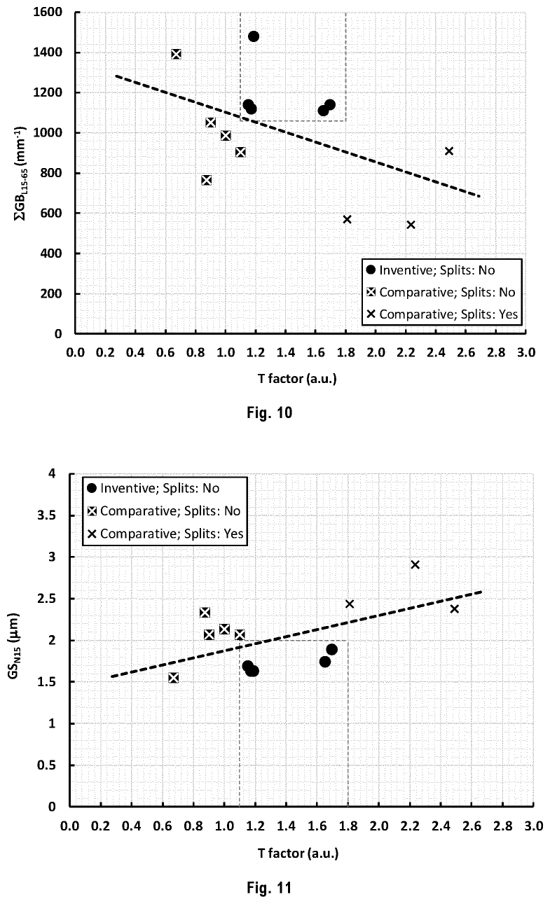

FIGS. 10 and 11 show the high-angle grain boundary density (ΣGBL₁₅₋₆₅) and average grain size by number based on a grain tolerance angle of 15° (GS_{N15}), respectively, against the T factor for inventive examples 1A-4A and 6A and comparative examples 5A, 7B, 8B, 10B, and 11B without splits upon shearing and comparative examples 9B, 12B, and 13B with splits upon shearing. These graphs illustrate the relevance of striking the correct balance between grain refinement (GS_{N15}≥2.0 μm) and promoting a sufficiently high-angle grain boundary density (ΣGBL₁₅₋₆₅≥1060 mm⁻¹) for sufficient fracture toughness in terms of average total crack length (ATCL≤10 mm) and work of fracture (WOF≥100 J) on the one hand and obtaining an acicular/bainitic ferrite and/or bainite microstructures with adequate MOD index (≥0.85) and X-ray random intensity ratios of specific texture fibres, segments, and components as featured in Table 3 yielding an adequate T factor (at least 1.1, and preferably not more than 1.8) to obtain a sufficiently high hole-expansion capacity (HEC≥45%) without risk of splitting upon shearing.

Examples 5A and 7A-13A are comparative as the work of fracture (WOF) is below 100 J due to insufficient grain refinement with an average grain size by number based on a grain tolerance angle of 15° (GS_{N15}) above 2.0 μm and a high-angle grain boundary density (ΣGB₁₅₋₆₅) of less than 1060 mm⁻¹. For all these comparative examples the fraction transformed from austenite to acicular/bainitic ferrite and/or bainite at the end of the run-out-table and prior to coiling (CTzm) is considerably lower than for the inventive examples. For the comparative examples 5A and 7A-13A the fraction transformed (CTzm) is less than 48% and in most cases even lower than 25%, whereas for the inventive examples 1A-4A and 6A this is higher than 50%. The lower fraction transformed for the comparative examples 5A and 7A-13A due to an unfavourable combination of process and alloy composition is closely linked with a slower rate of transformation and subsequent decreased grain refinement for these comparative examples compared to the inventive examples, leading for the comparative examples to a significantly higher crack susceptibility in terms of average total crack length (ATCL) and—foremost—a substantially lower work of fracture (WOF<100 J). Comparative example 5A has too low a hole-expansion capacity (HEC<45%) as IT_{ROT} is too high (IT_{ROT}>600° C.), leading to a final microstructure with too low an MOD index (<0.85) and too low an X-ray random intensity ratio of the γ-fibre (<27) and too low a T factor (<1.1). Comparative examples 7B, 8B, 10B, and 11B have too low a hole-expansion capacity (HEC<45%) due to a too low T factor (<1.1) and also too low work a fracture (WOF<100 J) due to too high an average grain size by number based on a grain tolerance angle of 15° (GS_{N15}>2.0 μm) and too low a high-angle grain boundary density (ΣGBL₁₅₋₆₅<1060 mm⁻¹). Comparative examples 9B, 12B, and 13B also have too low hole-expansion capacity (HEC<45%) and too low work of fracture (WOF<100 J), and in addition also exhibit splitting upon shearing (Splits: Yes). These comparative examples also have too high an average grain size by number based on a grain tolerance angle of 15° (GS_{N15}>2.0 μm) and too low a high-angle grain boundary density (ΣGBL₁₅₋₆₅<1060 mm⁻¹), leading to poor fracture toughness based on too high an average total crack length (ATCL>10 mm) and too low a work of fracture (WOF<100 J). Furthermore, their T factor is too high (>1.8), leading to high hole-expansion capacity (HEC≥45%) but unfortunately with splitting in the fractured zone of the sheared edge upon shearing.

TABLE 2
Process parameters applied and resultant properties.

| | | PROCESS | | | | | | | PERFORMANCE |
|---|---|---|---|---|---|---|---|---|---|
| | | RHT | FRT | CR₁ | IT_{ROT} | CR₂ | CT | CTzm | t |
| Steel | Alloy | (° C.) | (° C.) | (° C./s) | (° C.) | (° C./s) | (° C.) | (%) | (mm) |
| 1 | A | 1220 | 952 | 75 | 569 | 7 | 521 | 58 | 3.45 |
| 2 | A | 1220 | 953 | 75 | 578 | 15 | 486 | 53 | 3.45 |
| 3 | A | 1220 | 952 | 74 | 575 | 15 | 479 | 56 | 3.45 |
| 4 | A | 1220 | 935 | 68 | 590 | 17 | 480 | 57 | 3.45 |
| 5 | A | 1220 | 923 | 58 | 630 | 11 | 557 | 57 | 3.45 |
| 6 | A | 1220 | 918 | 71 | 563 | 6 | 524 | 59 | 3.45 |
| 7 | B | 1220 | 914 | 65 | 567 | 6 | 530 | 47 | 3.45 |
| 8 | B | 1220 | 927 | 72 | 560 | 6 | 523 | 39 | 3.45 |
| 9 | B | 1220 | 992 | 104 | 525 | 5 | 498 | 11 | 3.45 |
| 10 | B | 1220 | 935 | 65 | 602 | 10 | 537 | 22 | 3.45 |
| 11 | B | 1220 | 925 | 62 | 609 | 9 | 548 | 20 | 3.45 |
| 12 | B | 1220 | 977 | 94 | 554 | 2 | 540 | 11 | 3.45 |
| 13 | C | 1220 | 985 | 94 | 565 | 4 | 542 | 12 | 3.25 |

| | PERFORMANCE | | | | | | | | |
|---|---|---|---|---|---|---|---|---|---|
| | Rp | Rm | YR | A50 | HEC | ATCL | WOF | Splits | |
| Steel | (MPa) | (MPa) | (—) | (%) | (%) | (mm) | (J) | (Y/N) | Example |
| 1 | 666 | 761 | 0.88 | 18.3 | 64 | 0 | 157 | No | Inventive |
| 2 | 664 | 750 | 0.89 | 17.3 | 74 | 0 | 209 | No | Inventive |
| 3 | 662 | 738 | 0.90 | 17.6 | 55 | 0 | 237 | No | Inventive |
| 4 | 692 | 762 | 0.91 | 15.0 | 51 | 0 | 241 | No | Inventive |
| 5 | 700 | 788 | 0.89 | 16.7 | 32 | 0 | 156 | No | Comparative |
| 6 | 699 | 773 | 0.90 | 17.3 | 45 | 0 | 219 | No | Inventive |
| 7 | 725 | 811 | 0.89 | 12.8 | 34 | 3 | 47 | No | Comparative |
| 8 | 675 | 785 | 0.86 | 15.3 | 44 | 3 | 52 | No | Comparative |
| 9 | 623 | 800 | 0.78 | 16.3 | 74 | 67 | 24 | Yes | Comparative |
| 10 | 740 | 832 | 0.89 | 16.0 | 41 | 38 | 38 | No | Comparative |
| 11 | 751 | 833 | 0.90 | 17.7 | 42 | 38 | 38 | No | Comparative |
| 12 | 725 | 824 | 0.88 | 19.5 | 74 | 59 | 18 | Yes | Comparative |
| 13 | 760 | 820 | 0.93 | 16.0 | 80 | 102 | 39 | Yes | Comparative |

RHT: Reheating temperature
FRT: Finish rolling temperature
CR₁: Primary cooling rate on run-out-table
IT_{ROT}: Intermediate temperature run-out-table
CR₂: Secondary cooling rate on run-out-table
CT: Coiling temperature
CTzm Fraction transformed at coiler
t: Sheet thickness
Rp: Yield strength
Rm: Tensile strength
YR: Yield ratio
A50: Tensile elongation
HEC: Hole-expansion capacity
ATCL: Average total crack length
WOF: Work of fracture
Splits: Splitting (yes/no)

TABLE 3
Microstructure and texture characteristics.

| | | MICROSTRUCTURE | | | | TEXTURE (X-ray random intensity ratio) at ½-thickness | | | | | | | | |
|---|---|---|---|---|---|---|---|---|---|---|---|---|---|---|
| | | at ¼-thickness | | | | γ-fi- | θ-fi- | {110} | α*- seg- | {112} | (332} | {554} | T | |
| | | GS_{N15} | ΣGBL₁₅₋₆₅ | MOD | | bre | bre | <001> | ment | <131> | <113> | <225> | Factor | |
| Steel | Alloy | (μm) | (mm⁻¹) | (-) | Phases | (-) | (-) | (-) | (-) | (-) | (-) | (-) | (-) | Example |
| 1 | A | 1.89 | 1140 | 1.06 | F/B + C | 39.10 | 54.35 | 1.54 | 45.12 | 3.58 | 6.06 | 5.27 | 1.697 | Inventive |
| 2 | A | 1.74 | 1110 | 1.09 | F/B + C | 36.34 | 52.66 | 1.34 | 44.33 | 3.70 | 6.41 | 6.18 | 1.653 | Inventive |
| 3 | A | 1.63 | 1480 | 0.98 | F/B + C | 27.98 | 54.20 | 1.40 | 49.66 | 4.53 | 8.31 | 6.18 | 1.188 | Inventive |
| 4 | A | 1.69 | 1140 | 1.08 | F/B + C | 27.68 | 46.00 | 1.35 | 52.04 | 4.69 | 8.62 | 6.17 | 1.151 | Inventive |
| 5 | A | 1.55 | 1390 | 0.80 | F/B + C | 14.52 | 46.97 | 1.65 | 52.69 | 4.54 | 8.72 | 5.80 | 0.673 | Compar- |
| | | | | | | | | | | | | | | ative |
| 6 | A | 1.63 | 1120 | 1.05 | F/B + C | 31.16 | 43.85 | 0.70 | 49.59 | 4.49 | 8.18 | 6.24 | 1.172 | Inventive |
| 7 | B | 2.07 | 1050 | 0.89 | F/B + | 29.19 | 29.62 | 0.27 | 38.15 | 4.71 | 7.64 | 6.38 | 0.903 | Compar- |
| | | | | | M + C | | | | | | | | | ative |
| 8 | B | 2.07 | 903 | 0.93 | F/B + | 29.90 | 33.16 | 0.56 | 34.06 | 4.68 | 7.76 | 6.58 | 1.099 | Compar- |
| | | | | | M + C | | | | | | | | | ative |
| 9 | B | 2.38 | 909 | 0.99 | F/B + | 39.66 | 49.11 | 1.02 | 25.67 | 2.50 | 3.56 | 3.93 | 2.488 | Compar- |
| | | | | | M + C | | | | | | | | | ative |
| 10 | B | 2.13 | 986 | 0.91 | F/B + | 34.20 | 32.97 | 0.31 | 42.83 | 4.28 | 7.46 | 5.55 | 1.002 | Compar- |
| | | | | | M + C | | | | | | | | | ative |
| 11 | B | 2.33 | 765 | 0.69 | F/B + | 39.75 | 36.60 | 0.27 | 40.17 | 3.72 | 5.89 | 6.36 | 0.874 | Compar- |
| | | | | | M + C | | | | | | | | | ative |
| 12 | B | 2.44 | 570 | 0.81 | F/B + | 42.53 | 57.76 | 1.35 | 31.78 | 2.69 | 4.32 | 4.81 | 1.810 | Compar- |
| | | | | | M + C | | | | | | | | | ative |
| 13 | C | 2.91 | 542 | 0.99 | F/B | 42.31 | 60.18 | 2.62 | 30.99 | 3.79 | 5.91 | 5.74 | 2.237 | Compar- |
| | | | | | | | | | | | | | | ative |

GS_{N15}: Average grain size by number
ΣGBL₁₅₋₆₅: Grain boundary length
MOD: Misorientation distribution index
F: Acicular/bainitic ferriteB: BainiteC: CementiteM: Martensitea*- segment: X-ray random intensity ratio of {115} <110> to {223} <110>
$T = \frac{[ ( γ - fibre ) + ( θ - fibre ) + \{ 110 \} < 001 > ]}{\begin{matrix}[ ( {α}^{*} - segment ) + \{ 112 \} < 131 > + \\ \{ 332 \} < 113 > + \{ 554 \} < 225 > ]\end{matrix}} \times {MOD}^{1.2}$

### Example 2

Steels slabs of chemistry D according to the invention have been processed on an industrial scale and whereby the composition is given in Table 4 and the relevant processing parameters as used are given in Table 5. In this steel composition there is a purposive addition of Nb, whereas there is no purposive addition of Cr, Mo, and V. In Table 4 also α is given calculated using the formula given in Example 1.

The properties have been measured and the results are listed also in Table 5 and in Table 6 the microstructure and texture characteristics are given; all in the same way as set out in Example 1.

This example illustrates that a small addition of Nb contributes to the grain refinement of the steel when processed in accordance with the invention and providing for the required microstructural features delivering a favourable balance in properties, in particular high strength with a suitable hole-expansion capacity in combination with sufficient fracture toughness, work of fracture and no splitting upon shearing.

TABLE 4
Chemical composition of steel D, in wt. %. The balance is Fe and
inevitable impurities resulting from the iron making and steel
making process. Alloy D is an example according to the invention.

| | Element | | | | | | | | | | | |
|---|---|---|---|---|---|---|---|---|---|---|---|---|
| Alloy | C | Mn | Si | P | S | Al | Ti | Nb | B | N | Ti_sol | α |
| D | 0.079 | 1.81 | 0.34 | 0.010 | 0.000 | 0.040 | 0.114 | 0.016 | 0.0004 | 0.0050 | 0.097 | 3.006 |

Having now fully described the invention, it will be apparent to one of ordinary skill in the art that many changes and modifications can be made without departing from the spirit or scope of the invention as herein described.

TABLE 5
Process parameters applied and resultant properties.

| | | RHT | FRT | CR₁ | IT_{ROT} | CR₂ | CT | t | Rp | Rm | YR | A50 | HEC | ATCL | WOF | Splits | |
|---|---|---|---|---|---|---|---|---|---|---|---|---|---|---|---|---|---|
| Steel | Alloy | (° C.) | (° C.) | (° C./s) | (° C.) | (° C./s) | (° C.) | (mm) | (MPa) | (MPa) | (—) | (%) | (%) | (mm) | (J) | (Y/N) | Example |
| 14 | D | 1220 | 946 | 66 | 569 | 6 | 543 | 3.42 | 695 | 785 | 0.89 | 16.0 | 71 | 2.1 | 153 | No | Inventive |
| 15 | D | 1220 | 956 | 74 | 538 | 5 | 517 | 3.41 | 766 | 844 | 0.91 | 17.6 | 46 | 5.5 | 159 | No | Inventive |
| 16 | D | 1220 | 948 | 63 | 593 | 11 | 523 | 3.45 | 712 | 800 | 0.89 | 17.7 | 56 | 0.7 | 148 | No | Inventive |

TABLE 6
Microstructure and texture characteristics.

| | | | | | | γ- | θ- | | α*- | | | | T- | |
|---|---|---|---|---|---|---|---|---|---|---|---|---|---|---|
| | | GS_{N15} | ΣGBL₁₅₋₆₅ | MOD | | fibre | fibre | {110}<001> | segment | {112}<131> | {332}<113> | {554}<225> | factor | Exam- |
| Steel | Alloy | (μm) | (mm⁻¹) | (—) | Phases | (a.u.) | (a.u.) | (a.u.) | (a.u.) | (a.u.) | (a.u.) | (a.u.) | (—) | ple |
| 14 | D | 1.77 | 1120 | 1.00 | F/B + C | 38.02 | 48.20 | 0.19 | 53.95 | 6.04 | 9.70 | 7.47 | 1.120 | Inven- |
| | | | | | | | | | | | | | | tive |
| 15 | D | 1.59 | 1310 | 1.05 | F/B + C | 30.01 | 48.05 | 0.54 | 51.94 | 5.15 | 7.45 | 5.98 | 1.182 | Inven- |
| | | | | | | | | | | | | | | tive |
| 16 | D | 1.84 | 1150 | 1.11 | F/B + C | 27.34 | 48.71 | 0.21 | 51.98 | 5.05 | 7.70 | 6.07 | 1.221 | Inven- |
| | | | | | | | | | | | | | | tive |

1. A hot-rolled high-strength steel strip having a composition having, in wt. %,
C: 0.06-0.12 wt. %,
Mn: 1.20-2.20 wt. %,
Ti: 0.07-0.15 wt. %,
Si: up to 0.65 wt. %,
Al: up to 0.10 wt. %,
P: up to 0.02 wt. %,
S: up to 0.01 wt. %,
Nb: up to 0.03 wt. %,
N: up to 0.01 wt. %,
optionally one or more elements selected from the group consisting of:
(Cr: up to 0.25 wt. %, Mo: up to 0.10 wt. %, V: up to 0.30 wt. %, Cu: up to 0.20 wt. %, Ni: up to 0.50 wt. %, B: up to 0.005 wt. %),
and balance Fe and inevitable impurities;
and wherein the steel strip has a microstructure of:
precipitation-strengthened acicular/bainitic ferrite and/or bainite,
a MisOrientation Distribution (MOD) index of at least 0.85 at ¼-thickness,
at most 5 vol. % of second-phase constituents, including any cementite, pearlite, martensite, and/or retained-austenite,
an average grain size by number at ¼-thickness in the rolling direction and based on a grain tolerance angle of 15° (GS_{N15}) of at most 2.0 μm,
a total high-angle grain boundary length (ΣGBL₁₅₋₆₅) at ¼-thickness of at least 1060 mm⁻¹, and
γ-fibre X-ray random intensity ratio of at least 27 as measured with XRD at ½-thickness;
and wherein the steel strip has at least the following mechanical properties:
a yield strength (Rp0.2) ranging from 600 to 820 MPa,
an ultimate tensile strength (Rm) ranging between 730 and 950 MPa,
a tensile elongation (A50) of at least 11%,
a hole-expansion capacity (HEC) of at least 45%, and
a work of fracture (WOF) of at least 100 J.

2. The hot-rolled high-strength steel strip according to claim 1, wherein the composition has a Mn-content is in a range of 1.40 to 2.20 wt. %.

3. The hot-rolled high-strength steel strip according to claim 1, wherein the composition has a C content in a range of 0.070 to 0.12 wt. %.

4. The hot-rolled high-strength steel strip according to claim 1, wherein the composition has a Ti-content of at least 0.08 wt. %.

5. The hot-rolled high-strength steel strip according to claim 1, wherein the composition has a Si-content in a range of 0.10 to 0.65 wt. %.

6. The hot-rolled high-strength steel strip according to claim 1, wherein the composition has a Cr-content of up to 0.10 wt. %.

7. The hot-rolled high-strength steel strip according to claim 1, wherein the composition has a Nb content of up to 0.025 wt. %.

8. The hot-rolled high-strength steel strip according to claim 1, wherein the composition has:
$$a \leq \frac{( C / 12 )}{( Ti\_sol / 48 + Nb / 93 + V / 51 + Mo / 96} \leq b$$
$$with$$
$${Ti}_{sol} = Ti - ( \frac{48}{14} ) \times N ,$$
and a equals 1.8 and b equals 5.8.

9. The hot-rolled high-strength steel strip according to claim 1, wherein the microstructure has a T factor of at least 1.1, and preferably of at least 1.15 and more preferably of at least 1.4, and wherein T is defined as:
$$T = \frac{[ ( γ - fibre ) + ( θ - fibre ) + \{ 1 \; 10 \} < 001 > ]}{[ ( {α}^{*} - segment ) + \{ 1 \; 12 \} < 131 > + \{ 3 \; 32 \} < 113 > + \{ 5 \; 54 \} < 225 > ]} \times {MOD}^{1.2}$$
with MOD corresponding with the MisOrientation Distribution index at ¼-thickness and the featured texture fibres, segments, and components corresponding with the associated X-ray random intensity ratios at ½-thickness.

10. The hot-rolled high-strength steel strip according to claim 1, wherein the microstructure has at most 3 vol. % second-phase constituents, including any cementite, pearlite, martensite, and/or retained-austenite.

11. The hot-rolled high-strength steel strip according to claim 1, wherein the microstructure has a MisOrientation Distribution (MOD) index of at least 0.90 at ¼-thickness.

12. The hot-rolled high-strength steel strip according to claim 1, wherein the microstructure has a total high-angle grain boundary length at ¼-thickness in the rolling direction (ΣGBL₁₅₋₆₅) of at least 1100 mm⁻¹.

13. The hot-rolled high-strength steel strip according to claim 1, wherein the steel strip is provided with a metallic coating layer.

14. A method of manufacturing a hot-rolled high-strength steel strip according to claim 1, the method comprising the steps of:
casting a slab, followed by the step of reheating the solidified slab to a temperature between 1050° C. and 1260° C. and hot rolling said slab, or casting a slab or strip followed directly by the step of hot rolling said slab or strip;
hot rolling the steel slab or strip and finishing said hot rolling at a finish rolling temperature between 960° C. and Ar₃+20° C.
accelerated cooling of the hot-rolled steel strip with a run-out table primary cooling rate between 50-150° C./s to an intermediate temperature on the run-out table (IT_{ROT}) between 500° C. and 600° C.;
accelerated cooling of the hot-rolled steel strip with a run-out table secondary cooling rate of between 1-30° C./s;
coiling the hot-rolled and cooled strip at a coiling temperature between 450° C. and 580° C.;
allowing the coiled hot-rolled steel strip to further cool to ambient temperature;
optionally pickling of the hot-rolled steel strip; and
optionally providing of the hot-rolled steel strip with a metallic coating layer.

15. An automotive component made from the high-strength hot-rolled steel strip according to claim 1.

16. An automotive component made from the high-strength hot-rolled steel strip obtainable by the method according to claim 14.

17. The hot-rolled high-strength steel strip according to claim 1, wherein the composition has:
Mn—content of 1.40 to 2.10 wt. %;
C content of 0.07 to 0.10 wt. %;
Ti content of 0.09 to 0.13 wt. %;
Si—content of 0.25 to 0.50 wt. %;
Nb content of up to 0.02 wt. %.

18. The hot-rolled high-strength steel strip according to claim 8, wherein a equals 2.4 and b equals 3.8.

19. The hot-rolled high-strength steel strip according to claim 9, wherein the microstructure T factor is at least 1.4.

20. The hot-rolled high-strength steel strip according to claim 1, wherein the microstructure MisOrientation Distribution (MOD) index is at least 1.0.
